(19) United States
(12) Patent Application Publication
(10) Pub. No.: US 2008/0066228 A1
(43) Pub. Date: Mar. 20, 2008

(54) Supporting apparatus and nursing robot system

(76) Inventors: Yohei Kume, Osaka (JP); Soichiro Fujioka, Osaka (JP); Hirofumi Kawaguchi, Saga (JP); Yoshihiko Matsukawa, Nara (JP)

Correspondence Address: WENDEROTH, LIND & PONACK L.L.P., 2033 K. STREET, NW, SUITE 800, WASHINGTON, DC, 20006, US

(21) Appl. No.: 11/902,339

(22) Filed: Sep. 20, 2007

(30) Foreign Application Priority Data
Sep. 20, 2006 (JP) 2006-254316

(51) Int. Cl. A61G 7/10

(52) U.S. Cl. 5/81.1 C; 901/15; 901/2

(57) ABSTRACT

Each lifting portion includes a fixing portion and a sliding portion slidable relative to the fixing portion. The sliding portion has a placing surface on which a cared person can be placed, and the fixing portion includes an input portion used to input an operation instruction. The input portion can be located at a first position and a second position located more backward relative to the placing surface than the first position in a direction away from the cared person. Therefore, burdens of a carer can be reduced at the time of lifting up the cared person.

### BACKGROUND OF THE INVENTION

1. Field of the Invention

The present invention relates to a supporting apparatus for moving a person to be cared (cared person), who is lying on a bed or the like, to another location while supporting this person in a lying state and particularly to a supporting apparatus capable of lifting up a cared person by inserting a lifting portion for lifting up the cared person between the cared person and a bed or the like and a nursing robot system using such a supporting apparatus.

2. Description of the Background Art

There have been conventionally proposed various nursing robot systems for moving a so-called bedridden person, who is a cared person such as an elderly person or a sick person and cannot get out of bed, to another location by transferring him to transfer means such as a stretcher or wheelchair while supporting him in a lying state at the time of conducting a medical examination or rehabilitation, bathing, washing his face, and having a meal.

For example, there has been proposed a nursing robot system which assists a carer by performing an operation of lifting up a cared person from below instead of the carer. Specifically, the carer as a user of the system attaches supporting devices for lifting up the cared person to the leading ends of arms of an elevating apparatus, and operates operation levers at the rear ends of the supporting devices to elevate or lower the supporting devices (see, for example, Japanese Unexamined Patent Publication No. H10-295744).

There has been another nursing robot system in which a supporting device includes an endless belt mounted on a drive roller, and an operation lever at the rear end of the supporting device is operated to scoop up a cared person onto the supporting device by inserting the supporting device between the underside of the cared person and the top surface of a bed while rotating the endless belt by means of the drive roller (see, for example, Japanese Unexamined Patent Publication No. 2001-104378). Thus, the nursing robot system scoops up the cared person onto the supporting device and lifts up the scooped cared person even if the cared person is a person who cannot roll over or is not allowed to change his body position such as an unconscious patient after a surgery or a patient seen to show a dementia tendency.

However, in a so-called direct face-to-face nursing robot system with which a carer performs an operation while facing a cared person by shortening a distance between the cared person and the carer to give the cared person a sense of security, the carer needed to pull his arms backward in order to insert a supporting device between the cared person and a bed, lift up and pull the cared person toward his chest while holding him. Thus, there has been a problem that the carer takes such a posture imposing physical burdens on elbows and the like.

### SUMMARY OF THE INVENTION

In view of the problems residing in the prior art, an object of the present invention is to provide a supporting apparatus and a nursing robot system using such a supporting apparatus, which are capable of safely lifting up a cared person without causing a carer to take a posture imposing physical burdens on him and giving the cared person any sense of insecurity when the carer lifts up the cared person while supporting him.

In order to accomplish the above object, the invention is directed to a supporting apparatus for assisting an operation of holding up a cared person, comprising a placing surface on which the cared person can be placed; and an input portion for inputting an operation input, wherein the input portion can be located at a first position and a second position located more backward relative to the placing surface than the first position in a direction away from the cared person.

Since the position of the input portion relative to the placing surface can be changed in forward and backward directions according to the present invention, the input portion can be changed to a position easy to operate for a carer and burdens of a series of operations to hold up the cared person can be reduced. For example, if the input portion is held at the first position before the placing surface is inserted underneath the cared person, the input portion can be located closer to the cared person as compared to the case where it is located at the second position, wherefore the carer can more easily position the placing surface with respect to the bed and the cared person can be easily detect the placement of the supporting apparatus on the bed while gripping the input portion. Accordingly, the operability of the supporting apparatus can be improved and an operation of inserting the placing surface underneath the cared person can be easily performed. On the other hand, if the input portion is held at the second position when the placing surface is inserted underneath the cared person, the input portion is located at a position close to the carer, wherefore the carer can hold the cared person without bending over forward. Hence, a burden of the operation of the holding the cared person can be reduced. If the input portion is held at the first position upon pulling the placing surface toward the carer's chest after scooping up the cared person, the carer needs not excessively pull his elbows backward since the input portion is not too close to the carer. Thus, burdens during the operations of holding and pulling the cared person closer can be reduced. Neither does the input portion stand as a hindrance at the time of pulling the cared person closer. Further, the carer can hold the cared person in the same posture as he normally holds another person. Since the carer can hold up the cared person without being forced to take such a posture imposing burdens on him by displacing the input portion relative to the placing surface in this way, the burdens of the series of operations can be reduced.

### BRIEF DESCRIPTION OF THE DRAWINGS

FIG. 1 is a perspective view of a nursing robot system according to one embodiment of the invention,

FIG. 2 is a perspective view showing a used state of the nursing robot system,

FIG. 3A is a side view showing the vicinity of the leading end of a lifting portion, and FIG. 3B is a section along III-III of FIG. 3A,

FIG. 4A is a diagram showing rotation restriction of an input-portion supporting portion in this embodiment and FIG. 4B is a diagram showing rotation restriction of an input-portion supporting portion according to another embodiment,

FIG. 5 is a side view showing the vicinity of the leading end of a lifting portion according to another embodiment,

FIG. 6 is a side view of a sliding portion in this embodiment,

FIG. 7A is a side view of the lifting portion in this embodiment and FIG. 7B is a section along VII-VII of FIG. 7A,

FIG. 8 is a block diagram showing the electrical construction of this embodiment,

FIG. 9 is a flow chart showing the operation of this embodiment,

FIGS. 10A to 10H are diagrams showing the operation of a supporting apparatus of this embodiment,

FIGS. 11A to 11C are diagrams showing a lifting-up operation by means of a conventional lifting portion,

FIG. 12A is a side view showing an input-portion supporting portion according to another embodiment, FIG. 12B is a portion along XII-XII of FIG. 12A and FIG. 12C is a side view showing a state where an input portion is located at a lower position,

FIGS. 13A to 13E are diagrams showing the operation of another embodiment,

FIG. 14A is a side view of a sliding portion according to another embodiment and FIG. 14B is a portion along XIV/XIV of FIG. 14A,

FIG. 15 is a side view of a sliding portion according to another embodiment,

FIG. 16 is a perspective view of a nursing robot system according to another embodiment,

FIG. 17 is a section along XVII-XVII of FIG. 16,

FIGS. 18A to 18F are diagrams showing the operation of another embodiment,

FIGS. 19A to 19E are diagrams showing the operation of another embodiment,

FIGS. 20A to 20E are diagrams showing the operation of another embodiment,

FIGS. 21A and 21B are diagrams showing characteristic values necessary to calculate a contact position of a cared person and an operation lever, and FIG. 21C is a diagram showing a sensor for detecting the rear end of the cared person,

FIG. 22 is a flow chart showing the operation of another embodiment, and

FIG. 23 is a perspective view showing a lifting portion according to another embodiment.

### DESCRIPTION OF PREFERRED EMBODIMENTS

Hereinafter, best modes for embodying the present invention are described in detail with reference, to the accompanying drawings.

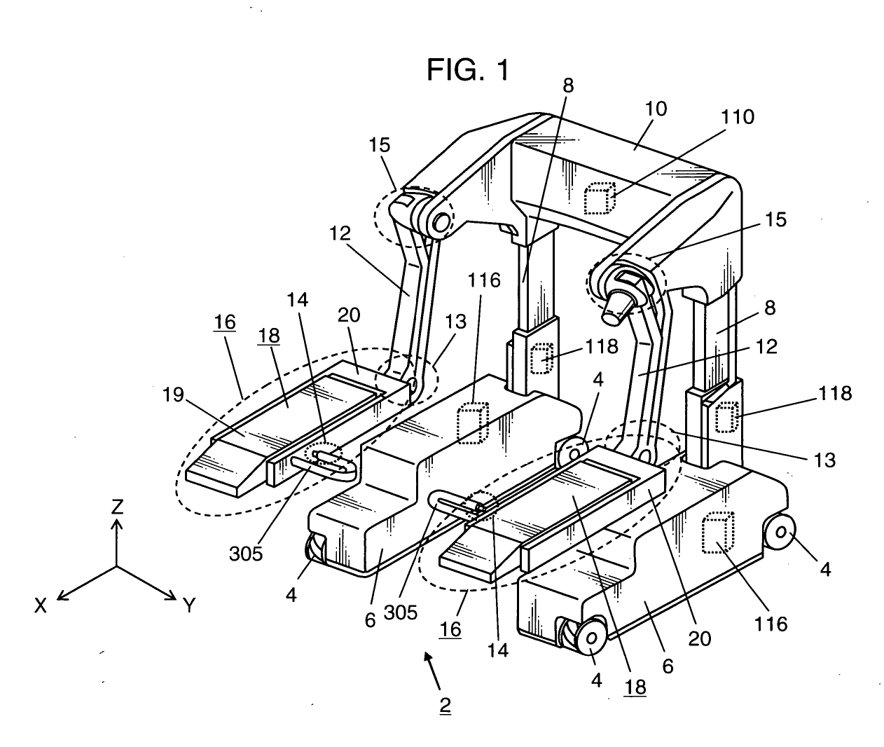

First, the construction of a supporting apparatus 2 in this embodiment is described. FIG. 1 is a perspective view showing the supporting apparatus 2 and a nursing robot system 1 including the supporting apparatus 2. In FIG. 1, three axes (X-axis, Y-axis and Z-axis) orthogonal to each other are shown in order to facilitate understanding. Here, an XY plane is a horizontal plane parallel to the ground, and lifting portions 16 are so attached to a main body 10 of the supporting apparatus 2 as to extend in an X-axis direction (i.e. the supporting apparatus 2 extends in the X-axis direction).

The nursing robot system 1 is a robot for moving a cared person lying on a bed or the like to another location while supporting him in a lying state. This robot can lift up the cared person by inserting the lifting portions 16 between the cared person and the bed and raising the lifting portions 16.

The supporting apparatus 2 is provided with the lifting portions 16 insertable underneath the cared person, e.g. between the cared person and the bed, and input portions 14 arranged near the leading ends of fixing portions 20 to input an operation instruction.

Since the input portions 14 can be thus operated near the leading ends of the lifting portions 16, a carer needs not pull back his elbows and is not forced to take an improper posture when pulling the cared person toward his chest after scooping up the cared person by means of the lifting portions 16.

The nursing robot system 1 is provided with a pair of arm portions 12 supporting the pair of the lifting portions 16 respectively, the main body 10 supporting the both arm portions 12, two joint portions 13 rotatably holding the arm portions 12 and the lifting portions 16, two joint portions 15 rotatably holding the main body 10 and the arm portions 12, moving portions 4 for moving holders 6 holding the entire apparatus, leg portions 8 connecting the holders 6 and the main body 10 and including elevation driving devices 118 for elevating and lowering the main body 10, position driving devices 116 for driving the moving portions 4, and a controller 110 for controlling the position driving devices 116 and the elevation driving devices 118 in accordance with operation instructions from the input portions 14.

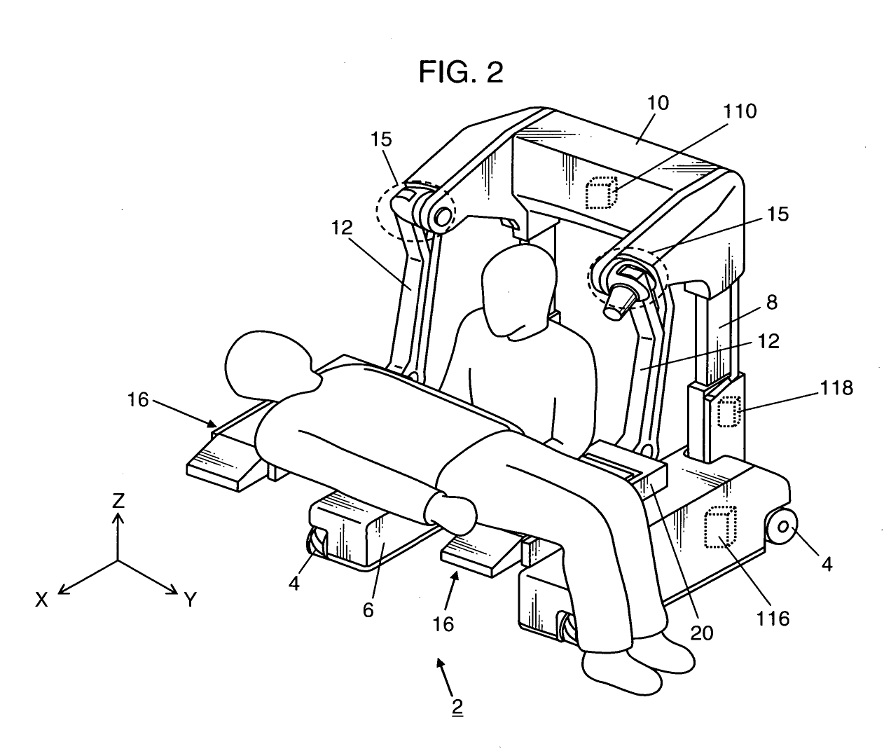

As shown in FIG. 2, the carer turns his palms upward while standing between the main body 10 and the pair of lifting portions 16 and facing in the X-axis direction with his back faced toward the main body 10, and operates the input portions 14 with both hands to make inputs for various operations of, e.g. moving the entire supporting apparatus 2, moving the lifting portions 16 and lifting up the cared person.

Here, the respective component parts of the supporting apparatus 2 are described in detail.

Known input devices such as levers, buttons, push switches or touch panels can be used as the input portions 14. The input portions 14 are supported on input-portion supporting portions 305 near the leading ends of the fixing portions 20 of the lifting portions 16. At the respective lifting portions 16, the input portions 14 are both arranged at sides toward the carer, i.e. at inner sides.

The input-portion supporting portions 305 are rotatably supported on the fixing portions 20. As a result, each input portion 14 can be positioned at least at four positions, i.e. front position, back position, upper position and lower position. The front position is a position where the input portion 14 is located more forward (toward the leading end) than the input-portion supporting portion 305. In other words, the input portion 14 is located more toward the leading end with respective to the fixing portion 20 at the front position. On the other hand, the back position is a position where the input portion 14 is located more backward (toward the base end) than the input-portion supporting portion 305. In other words, the input portion 14 is located more toward the base end with respective to the fixing portion 20 at the back position. At the upper and lower positions, the input portion 14 is located at middle positions in its movable range with respect to forward and backward directions.

Thus, the carer can give operation inputs after moving the input portions 14 to positions enabling easy operations upon inputting instructions for various operations. Since the positions of the input portions 14 can be changed to those enabling easy operations, the cared person can be safely lifted up without causing the carer to take a posture imposing physical burdens on him. For example, the input portions 14 are located at the front positions if the carer needs to position the leading ends of the lifting portions 16 on the bed or needs to detect the placement of the lifting portions 16 on the bed. Further, the input portions 14 are located near the back positions if the carer needs to narrow an interval between the pair of lifting portions 16 after scooping up the cared person. In this way, the carer can operate the lifting portions 16 from behind and can operate the input portions 14 without being sandwiched between the pair of lifting portions 16. The input-portion supporting portions 305 are described in detail later.

Each input portion 14 has an input switch provided on a cylindrical outer circumferential surface and a side surface thereof, and is supported on an end of the substantially U-shaped input-portion supporting portion 305. Specifically, each input-portion supporting portion 305 is arranged on a side surface of the corresponding fixing portion 20 facing the carer, and is U-turned and extends in a direction away from the carer after extending toward the carer. The input portion 14 is disposed at the leading end of the input-portion supporting portion 305.

By such a construction, the carer can operate the switches of the input portions 14 using his thumbs even with his palms turned upward, operability for the carer can be improved, exhibiting high practicability.

The joint portions 13 are constructed to rotate the lifting portions 16 in two axis directions, i.e. a direction about the Y-axis and a direction about the X-axis in FIG. 1, relative to the arm portions 12. By this construction, angles of the lifting portions 16 with respect to the cared person can be adjusted.

The joint portions 15 are constructed to rotate the arm portions 12 in two axis directions, i.e. the direction about the Y-axis and the direction about the X-axis in FIG. 1, relative to the main body 10. By this construction, the width between the lifting portions 16 can be adjusted and distances between the lifting portions 16 and the cared person can be adjusted. It is also possible to adjust the lifting portions 16 so as not to transversely incline or so as to transversely incline depending on the cared person.

The leg portions 8 are constructed to elevate and lower the main body 10 relative to the holders 6 by means of the elevation driving devices 118. By this construction, the height of the lifting portions 16 can be adjusted according to the height of the bed.

The moving portions 4 are a mechanism for moving the position of the supporting apparatus 2, and known moving means such as wheels driven by a motor can be used as such.

The lifting portions 16 are arranged at the opposite ends of the supporting apparatus 2 with respect to the Y-axis direction and each of them includes the fixing portion 20 as a base frame of the lifting portion 16 and a sliding portion 18 arranged movably forward and backward relative to the fixing portion 20. The upper surfaces of the sliding portions 18 serve as placing surfaces 19 on which the cared person can be placed. When the sliding portions 18 are at retracted positions, the front ends of the sliding portions 18 project slightly more forward than those of the fixing portions 20. These projecting front ends are tapered to become gradually thinner toward the front.

The sliding portions 18 are slidable forward and backward relative to the fixing portions 20. Sliding movements can be made between the retracted positions and advanced positions located more forward than the retracted positions. The length of this stroke is set, considering the widths of human backs and whether or not the projecting amount ensures the safe support of the sliding portions 18 with a person placed on the sliding portions 18.

On the other hand, as already mentioned, the input portions 14 are also displaceable forward and backward relative to the fixing portions 20. The input portions 14 are located at the most forward positions relative to the sliding portions 18 (placing surfaces 19) when the sliding portions 18 are at the retracted positions and the input portions 14 are at the front positions. Specifically, when the input portions 14 are seen in a coordinate system based on the placing surfaces 19, the input portions 14 are located at first positions that are most forward relative to the sliding portions 18. When the input portions 14 are at the first positions, they can be closest to the cared person. This embodiment is set such that the fingers of the carer's hands gripping the input portions 14 in this state can reach the cared person.

On the other hand, the input portions 14 are located at positions closest to the base ends of the sliding portions 18 when the sliding portions 18 are advanced positions and the input portions 14 are at the back positions. In this case, the input portions 14 are most distant from the leading ends of the lifting portions 16 (leading ends of the sliding portions 18). With the sliding portions 18 located at the advanced positions, the input portions 14 are sufficiently distant from the leading ends of the sliding portions 18 regardless of whether the input portions 14 are located at the front positions or at the back positions. In this state, the input portions 14 are at second positions relatively located more backward than the first positions. In a coordinate system based on the placing surfaces 19, the input portions 14 can be located at least at two positions, i.e. the first positions and second positions in a horizontal direction.

When the input portions 14 are at the second positions, the input portions 14 are left close to the carer even when the sliding portions 18 are inserted underneath the cared person. Thus, the carer can hold the cared person without bending over forward, and can operate the input portions 14 in a posture with less burden. Further, even if a stroke of the arm portions 12 in forward and backward directions is made smaller, inserted positions and supporting positions where the cared person is supported can be changed by extending or retracting the sliding portions 18, wherefore positioning can be easily performed. Thus, operability can be ensured and the system can be miniaturized even if the arm portions 12 are designed to be short. The lifting portions 16 are described in detail later.

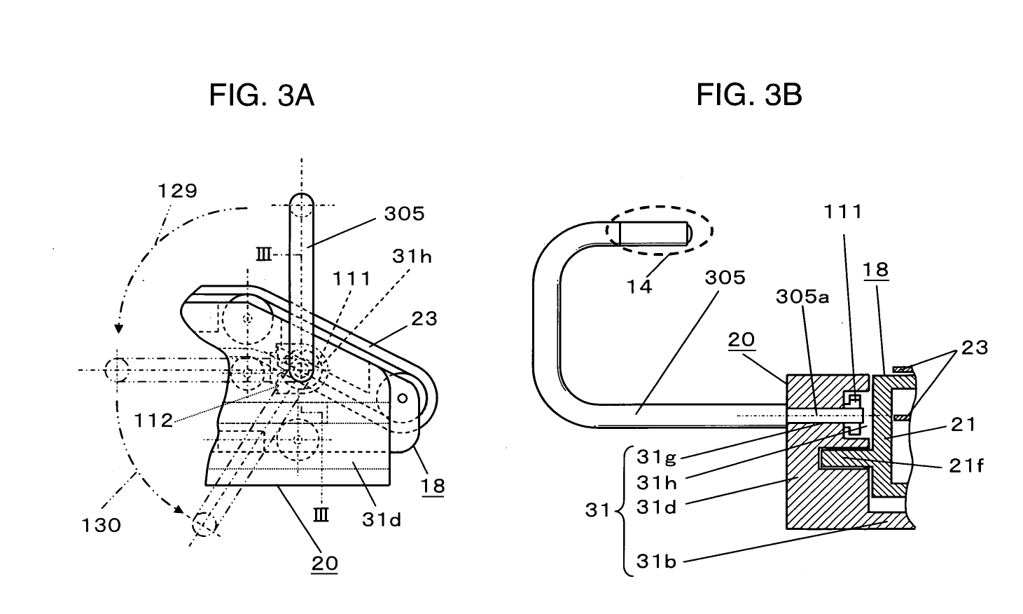

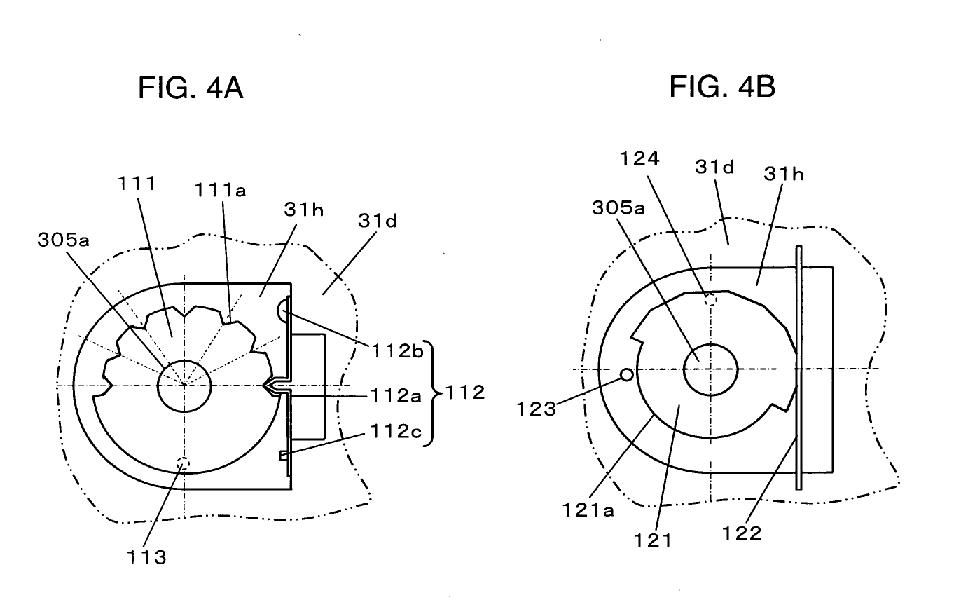

Next, the input-portion supporting portion 305 is described in detail with reference to FIGS. 3A, 3B and 4A and 4B. FIG. 3A is a side view showing an essential part of the input-portion supporting portion of the supporting apparatus according to this embodiment, and FIG. 3B is a section along III-III of FIG. 3A. FIG. 4A is a partial front view showing rotation restriction in the input-portion supporting portion of the supporting apparatus, and FIG. 4B is a partial front view showing another example of the rotation restriction of the input-portion supporting portion of the supporting apparatus.

As shown in FIGS. 3A and 3B, the input-portion supporting portion 305 has a rotary shaft 305a at one end, which is rotatably supported in a rotary shaft hole 31g formed in a side surface 31d of a fixed frame portion 31 of the fixing portion 20. The input-portion supporting portion 305 has a cam plate 111 secured to an end opposite to the rotary shaft 305a. The cam plate 111 rotates as the input-portion supporting portion 305 rotates.

Further, as shown in FIG. 4A, the cam plate 111 is formed with a plurality of substantially V-shaped cam grooves 111a, and a position restricting spring 112 including a substantially V-shaped position restricting portion 112a to be fitted into the cam grooves 111a is so mounted in the fixed frame portion 31 as to come into contact with a cam surface of the cam plate 111. The outer periphery of the cam plate 111 has an area where the cam grooves 111a are not formed, and the rotation of the cam plate 111 is restricted by the substantially V-shaped position restricting portion 112a of the position restricting spring 112. In this way, the rotatable range of the input-portion supporting portion 305 is restricted.

One end of the position restricting spring 112 is secured using a fastening member 112b such as a screw, and the other end thereof is movable straight by being guided by a pin 112a along an oblong hole (not shown) into which the pin 112a is fittable. Accordingly, the input-portion supporting portion 305 can be rotated in a direction of an arrow 129 and can be positioned at positions corresponding to the cam grooves 111a. Thus, the input-portion supporting portion 305 can be rotated in directions of arrows 129, 130 as shown in FIG. 3A, thereby changing the height of the input portion 14.

An input position detector 113 for detecting an operating position where the input portion 14 is operated is disposed in a recess 31h. The input position detector 113 detects operating position information representing whether the operating position of the input portion 14 is located above or below a connected position with the input-portion supporting portion 305 by detecting the presence or absence of a reflecting object at the outer peripheral area of the cam plate 111. For example, a reflection-type detection device as an integral unit of known light emitting element and light receiving element for detecting the presence or absence of the reflecting object may be used as the input position detector 113. Thus, there is no reflecting surface due to a smaller diameter in parts of the outer peripheral area of the cam plate 111 where the cam grooves 111a are formed, and the input position detector 113 detects the absence of the reflecting object. On the other hand, the cam plate 111 becomes the reflecting object due to a larger diameter in parts of the outer peripheral area thereof where the cam grooves 111a are not formed, and the input position detector 113 detects the presence of the reflecting object. The rotated position of the input-portion supporting portion 305 can be detected by detecting the presence or absence of the reflecting object at the outer peripheral area of the cam plate 111 in this way. Further, by disposing the input position detector 113 near the center of the part of the outer peripheral area where no cam grooves 111a are formed, a substantially central position of the rotatable range of the input-portion supporting portion 305 can be detected. For example, the operating position information representing whether the operating position where the input position 14 is operated is located above or below the connected position of the input-portion supporting portion 305 with the lifting portion 16 can be detected. Thus, the controller 110 can move or stop the sliding portion 18 based on the operated position information obtained from the input position detector 113. For example, the controller 110 executes such a control as to stop the sliding portion 18 if the operating position of the input portion 14 is located above the connected position of the input-portion supporting portion 305 with the lifting portion 16 and there is a possibility that the cared person lying on the placing surface 19 comes into contact with the input portion 14 while moving the sliding portion 18 without stopping it if the operating position is located below the connected position.

Members such as the cam plate 111 and the position restricting spring 112 are arranged in the recess 31h formed in the side surface 31d of the fixed frame portion 31, thus being prevented from hindering the movement of the sliding portion 18.

Instead of forming the cam plate 111 with the cam grooves 111a, a flat spring 122 may be held in contact with a cam plate 121 having a cam surface with n sides as shown in FIG. 4B. At this time, the rotatable range of the input-portion supporting portion 305 is restricted by a position restricting pin 123 provided in the recess 31h formed in the side surface 31d and a recess 121a formed in the cam plate 121.

An input position detector 124 for detecting the position of the input portion 14 is disposed in the recess 31h, and detects the presence or absence of a reflecting object at the outer peripheral area of the cam plate 121. Thus, the operating position information representing whether the position of the input portion 14 is located above or below the connected position of the input-portion supporting portion 305 can be detected by disposing the input position detector 124 at a specified position, e.g. at a position near the center of a part of the outer peripheral area formed with the cam surface (part having a larger diameter than a part formed with no cam surface). Thus, the controller 110 moves or stops the sliding portion 18 based on the operated position information obtained from the input position detector 124. For example, the controller 110 executes such a control as to stop the sliding portion 18 if the operating position of the input portion 14 is located above the connected position of the input-portion supporting portion 305 with the lifting portion 16 and there is a possibility that the cared person lying on the placing surface 19 comes into contact with the input portion 14 while continuing to move the sliding portion 18 if the operating position is located below the connected position.

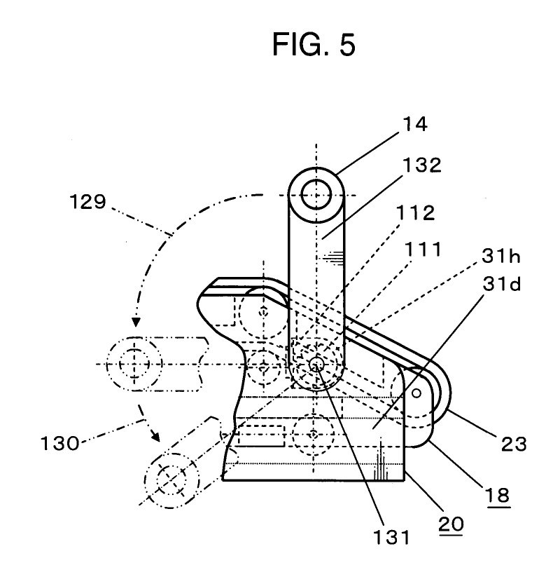

Instead of rotating the input-portion supporting portion 305 substantially in U-shape, the input portion 14 may be supported on a rotary arm and the position of the input portion 14 may be changed by rotating the rotary arm. An embodiment in this case is described with reference to FIG. 5. FIG. 5 is a side view showing another example of the input-portion supporting portion 305 of the supporting apparatus 2 in this embodiment.

In this example, as shown in FIG. 5, the height of the input portion 14 can be changed by rotating an rotary arm 132 having the input portion 14 arranged at one end and having a rotary shaft 131 secured to the other end and restricting the rotation of the rotary arm 132 by the cam plate 111 secured to the rotary shaft 131 and the position restricting spring 112.

As still another example, the rotary arm 132 may be made of a plurality of members telescopically connected with each other, so that the length thereof is adjustable. For example, a known telescopic mechanism including a plurality of members having tubular shapes with different diameters and connected with smaller ones fitted in larger ones while overlapping each other. The position of the input portion 14 can be changed by this telescopic mechanism.

By adopting such a construction to rotate the input-portion supporting portion 305 to make the height of the input portion 14 changeable, an instruction can be given to insert the sliding portions 18 between the cared person and the bed by raising the input portions 14 to the positions higher than the sliding portions 18 as shown in FIG. 3A if the height of the bed or the like on which the cared person is lying is low. Then, the input portions 14 can be operated without forcing the carer to take an improper posture such as a bending-over posture at the time of inserting the sliding portions 18.

Further, the input-portion supporting portions 305 can be rotated in the direction of the arrow 129 to bring the input portions 14 to the front positions when the lifting portions 16 are placed on the bed or the like, so that the positions of the input portions 14 can be adjusted to bring the hands of the carer to the same height as the lower surfaces of the lifting portions 16. Thus, the carer can recognize the contact of his hands with the bed while operating the input portions 14 and can precisely know that the lifting portions 16 have been placed on the bed or the like.

Further, in the case of pulling the cared person toward the fixing portions 20 with the cared person carried on the sliding portions 18, the input-portion supporting portions 305 can be rotated in the direction of the arrow 129 to lower the input portions 14 immediately before the sliding portions 18 move backward, simultaneously with the start of the backward movements or before the contact of the cared person with the input portions 14. This can prevent the input portions 14 from coming into contact with the cared person. The positions of the input portions 14 may be changed to such positions where the tips of the hands of the carer touch the cared person earlier than the sliding portions 18 by rotating the input portions 14 in a direction opposite to the direction of the arrow 129. This can prevent accidents such as the inadvertent contact of the leading ends of the lifting portions 16 with the cared person when the lifting portions 16 are inserted underneath the cared person, wherefore a sense of security can be improved both for the carer and the cared person. Since the same holds in the case of withdrawing the sliding portions 18 when the cared person is moved to another bed, such a case is not described.

Next, the construction of the lifting portions 16 is described in detail. Here, the lifting portion 16 arranged to the left of the carer is described.

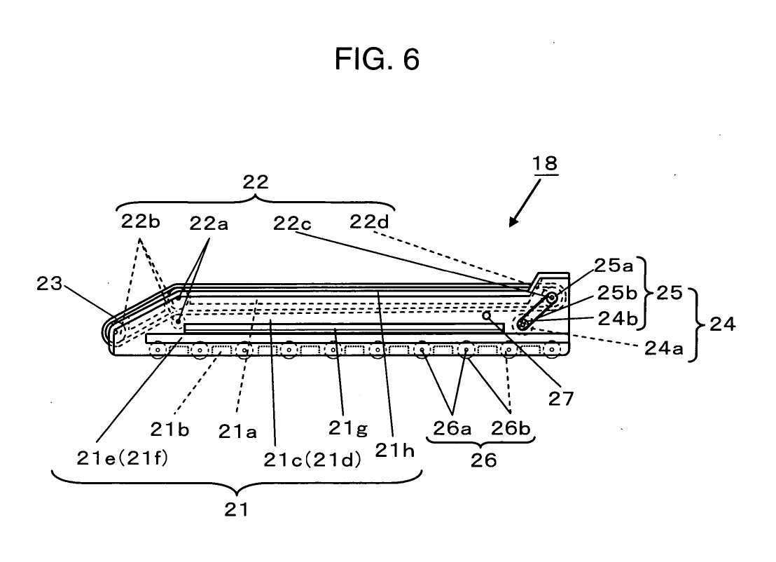

First, the sliding portion 18 movable while supporting the cared person is described with reference to FIG. 6. FIG. 6 is a side view of the sliding portion 18 of the supporting apparatus 2 in this embodiment.

As shown in FIG. 6, the sliding portion 18 includes a slide frame portion 21, a belt guiding roller array 22, a belt portion 23 and a belt driving device 24 and a roller array 26.

The slide frame portion 21 has a flat plate portion 21a, a bottom plate portion 21b facing the flat plate portion 21a, left and right side surface portions 21c, 21d, sliding plate portions 21e, 21f projecting outward from the left and right side surface portions 21c, 21d, a rack gears 21g and a cover portion 21h mounted on the sliding plate portions 21e.

The belt guiding roller array 22 includes a plurality of belt rollers 22b rotatably mounted on a plurality of belt roller shafts 22a extending from one side surface portion 21c of the slide frame portion 21 to the other side surface portion 21d, and a belt driving roller 22d secured to a drive roller shaft 22c extending from the one side surface portion 21c through the other side surface portion 21c and rotatably supported in fitting holes of the opposite side surface portions 21c, 21d.

The belt portion 23 in the form of an endless belt is mounted on the belt guiding roller array 22 and turns as the belt driving roller 22d rotates. An upper half of the belt portion 23 passes above the flat plate portion 21a of the slide frame portion 21. Thus, the cared person can be moved while being carried on the belt portion 23. In other words, the placing surface 19 is formed by the upper half of the belt portion 23.

The belt driving device 24 includes a belt driving motor 24a mounted on the side surface portion 21d of the slide frame portion 21, and a belt driving mechanism portion 25. The belt driving mechanism portion 25 includes a belt wheel 24b secured to an end of a rotary shaft of the belt driving motor 24a, a belt wheel 25a secured to a projecting part of the drive roller shaft 22c from the side surface portion 21d, and a drive belt 25b mounted between the belt wheels 24b, 25a.

Thus, when the belt driving motor 24a is rotated, the belt driving roller 22d is rotated via the belt driving mechanism portion 25 and the belt portion 23 mounted on the belt guiding roller array 22 is turned.

The roller array 26 includes a plurality of rollers 26b rotatably mounted on a plurality of roller shafts 26a extending from the one side surface portion 21c of the slide frame portion 21 to the other side surface portion 21d, and the rollers 26b partly project downward from the ends of the side surface portions 21c, 21d of the slide frame 21 at the bottom surface portion 21b.

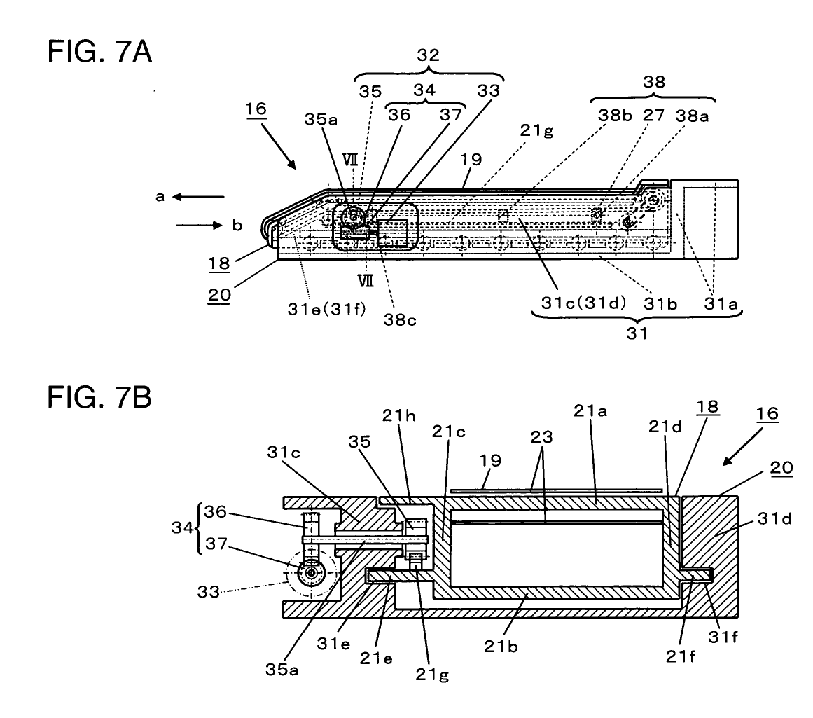

Next, the construction of the lifting portions 16 is described with reference to FIGS. 7A and 7B. FIG. 7A is a side view of the lifting portion 16 of the supporting apparatus 2 in this embodiment, and FIG. 7B is a section along VII-VII of FIG. 7A.

Each fixing portion 20 includes the fixed frame portion 31 and a slide driving device 32. The fixed frame portion 31 includes a connecting portion 31a, a bottom surface portion 31b and side surface portions 31c, 31d at the opposite sides of the bottom surface portion 31b. Slide grooves 31e, 31f are formed at inner sides of the side surface portions 31c, 31d, and the sliding plate portions 21e, 21f provided in the sliding portion 18 are held in the slide grooves 31e, 31f to be slidable forward and backward.

The slide driving device 32 includes a slide driving motor 33 mounted on the side surface portion 31c, a transmitting portion 34 and a pinion gear 35. The pinion gear 35 is so arranged as to be engaged with the rack gear 21g bonded to the sliding portion 18. A rotary shaft 35a secured to the pinion gear 35 is rotatably supported on the side surface portion 31c.

The transmitting portion 34 includes a worm wheel 36 secured to one end of the rotary shaft 35a of the pinion gear 35, and a worm 37 secured to the rotary shaft of the slide driving motor 33 and arranged to be engaged with the worm wheel 36. The transmitting portion 34 transmits a torque of the slide driving motor 33 to the pinion gear 35. In this way, the rack gear 21g of the sliding portion 18 engaged with the pinion gear 35 moves straight.

Instead of the worm wheel 36 and the worm 37 as the transmitting portion 34, belt transmitting means using belt wheels and a belt mounted on these belt wheels or another known drive transmitting means may be used.

As shown in FIGS. 6, 7A and 7B, the lifting portion 16 is provided with a moving position detector 38 including a light emitting element 27 arranged on the side surface portion 21c of the slide frame portion 21 of the sliding portion 18, light receiving elements 38a, 38b and 38c facing the light emitting element 27 and arranged on the side surface portion 31c of the fixed frame portion 31 of the fixing portion 20.

The light receiving element 38a specifies a starting end position (retracted position) of a movable area of the sliding portion 18. Specifically, when the sliding portion 18 is at the starting end position, light emitted from the light emitting element 27 provided in the sliding portion 18 can be received by the light receiving element 38a provided in the fixing portion 20. The controller 110 detects that the sliding portion 18 is at the starting end position when the light receiving element 38a receives the light from the light emitting element 27, and stops the movement of the sliding portion 18. This hinders a movement of the sliding portion 18 to the right (direction of an arrow “b”) from the starting end position.

The light receiving element 38c specifies a terminus end position (advanced position) of the movable area of the sliding portion 18. Specifically, when the sliding portion 18 is at the terminus end position, light emitted from the light emitting element 27 can be received by the light receiving element 38c. The controller 110 detects that the sliding portion 18 is at the terminus end position when the light receiving element 38c receives the light from the light emitting element 27, and stops the movement of the sliding portion 18. This hinders a movement of the sliding portion 18 to the left (direction of an arrow “a”) from the terminus end position.

The controller 110 detects that the sliding portion 18 is at a specified location, e.g. a location where there is a possibility that the input portion 14 and the cared person come into contact and temporarily stops the movement of the sliding portion 18 when the light receiving element 38b receives the light from the light emitting element 27.

In this way, the controller 110 detects the position information of the sliding portion 18 to control the operation of the sliding portion 18 by means of the moving position detector 38 including the light emitting element 27 and the light receiving elements 38a, 38b and 38c.

The controller 110 also causes the input position detector 113 to detect the operating position information of the input portion 14 and, in accordance with this input position information and the position information of the sliding portion 18 detected by the moving position detector 38, executed such a control as to stop the sliding portion 18 if there is a possibility that the cared person on the sliding portion 18 comes into contact with the input portion 14 while moving the sliding portion 18 if there is no longer such possibility. This control is described in detail later.

The lifting portion 16 arranged to the right of the carer may be constructed to be transversely symmetrical with the above lifting portion 16 arranged to the left of the carer, and this construction is not described here.

The operation of the sliding portion 18 of the lifting portion 16 constructed as above is described.

First, when the slide driving motor 33 is rotated in clockwise direction in FIG. 7B with the sliding portion 18 located at the starting end position, the pinion gear 35 is rotated via the transmitting portion 34. Thus, the rack gear 21g engaged with the pinion gear 35 is pushed forward (in the direction of the arrow “a” in FIG. 7A) relative to the fixing portion 20. In this way, the sliding portion 18 of the lifting portion 16 is moved forward (direction of the arrow “a” in FIG. 7A) relative to the fixing portion 20. In other words, the sliding portion 18 advances. At this time, the belt driving motor 24a of the sliding portion 18 is rotated in the same direction as the slide driving motor 33 immediately before or simultaneously with the rotation of the slide driving motor 33, thereby rotating the belt driving roller 22d via the belt driving mechanism portion 25. By this rotation of the belt driving roller 22d, the upper half of the belt portion 23 turns in a direction opposite to the moving direction of the sliding portion 18. The rotating speed of the belt driving roller 22d is controlled by the controller 110 so that, at this time, the belt portion 23 moves substantially at the same speed as the moving speed of the sliding portion 18.

As a result, a relative speed of the upper half of the belt portion 23 in contact with the cared person becomes substantially “0” when the sliding portion 18 is inserted underneath the cared person, wherefore the sliding portion 18 can be inserted without the cared person and the belt portion 23 rubbing against each other.

When the slide driving motor 33 is rotated in counterclockwise direction, the sliding portion 18 is moved backward (direction of the arrow “b” in FIG. 7A).

The two sliding portions 18 provided in this embodiment may be independently controlled to move. In such a case, even if the cared person is obliquely lying on the bed, the positions of the placing surfaces 19 can be independently adjusted by the sliding amounts of the sliding portions 18 after the positions of the fixing portions 20 are adjusted. In this way, it is possible to easily place the cared person on the placing surfaces 19 while coping with his posture lying on the bed or the like such as an oblique posture. Further, upon moving the cared person to another bed, the cared person can be so laid as not to be oblique to the bed and as to optimize the posture or position.

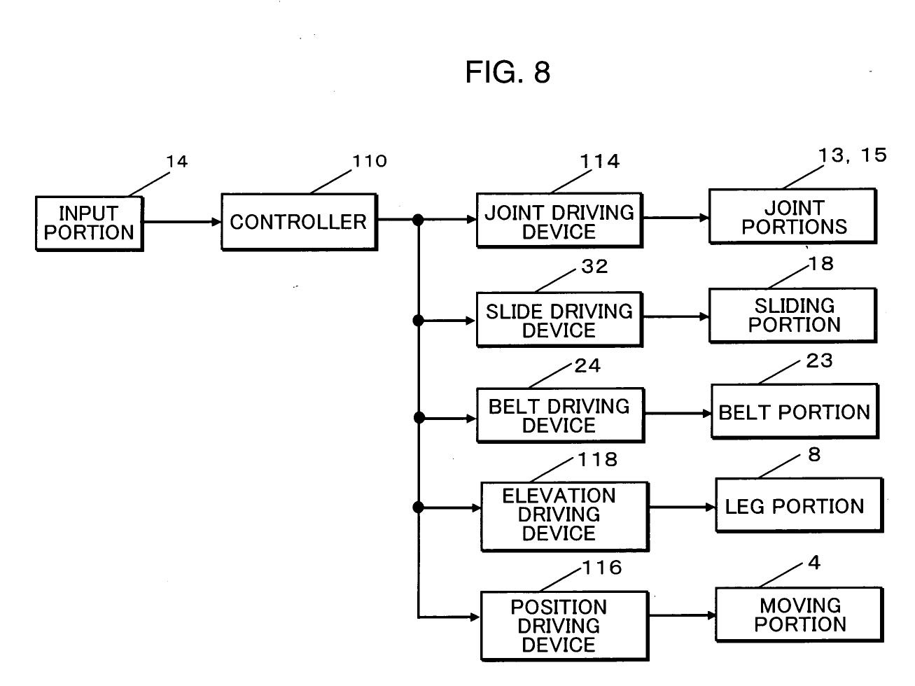

Next, the electrical construction of the nursing robot system 1 is described. FIG. 8 is a block diagram showing the electrical construction of the supporting apparatus 2 according to this embodiment.

As shown in FIG. 8, the nursing robot system 1 is provided with the input portions 14 to which the carer gives operation inputs, joint driving devices 114 for rotating the joint portions 13, 15, the slide driving devices 32 for moving the sliding portions 18 forward and backward relative to the fixing portions 20, the belt driving devices 24 for rotating the belt portions 23, the leg portions 8 for elevating and lowering the main body 10 relative to the holders 6, the elevation driving devices 118 for driving the leg portions 8, position driving devices 116 for driving the moving portions 4, and the controller 110 for controlling the joint driving devices 114, the slide driving devices 32, the belt driving devices 24, the elevation driving devices 118 and the position driving devices 116 based on the inputs to the input portions 14.

Known rotary motors may be used as the slide driving devices 32 for moving the sliding portions 18 forward and backward relative to the fixing portions 20. Alternatively, known rotary-linear motors may also be used as the slide driving devices 32. In such a case, the sliding portions 18 are driven by linear motors made of, e.g. electromagnets, electric motors, liquid pressure cylinders utilizing hydraulic pressure or like pressure, gas cylinders utilizing air pressure or like pressure to move forward and backward relative to the fixing portions 20.

Known driving means such as motors may be used as the joint driving devices 114, the belt driving devices 24, the elevation driving devices 118 and the position driving devices 116.

Known bearing mechanisms rotatable about two axial directions may be used as the joint portions 13, 15.

Known linearly movable mechanisms may be used as the elevation driving devices 118.

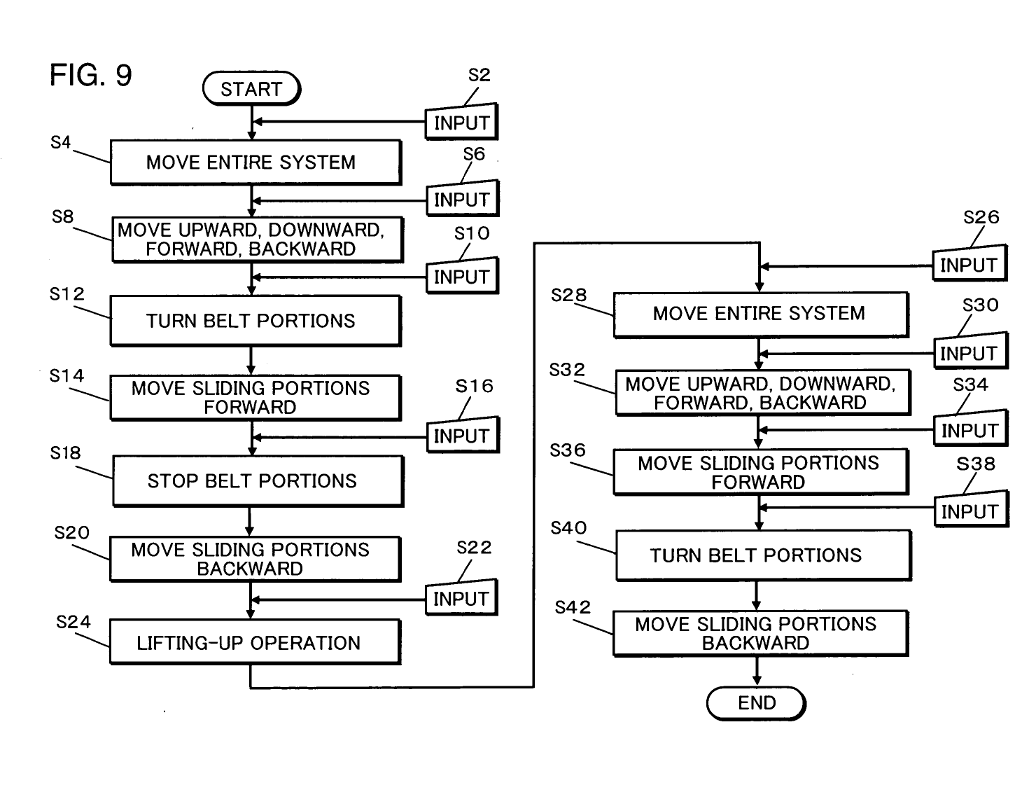

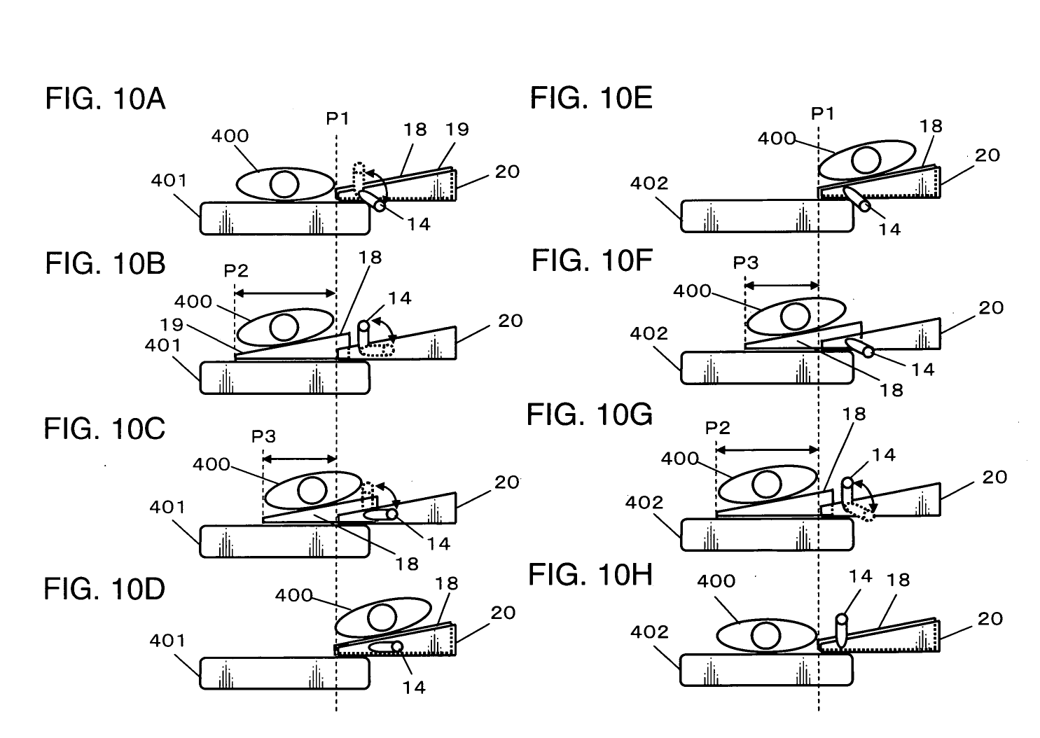

Next, the operation of the nursing robot system 1 is described with reference to FIGS. 9 and 10A to 10H. FIG. 9 is a flow chart showing the operation of the nursing robot system 1 according to this embodiment, and FIGS. 10A to 10H are diagrams showing the operation of the supporting apparatus 2 according to this embodiment. Here is described an example in which the supporting apparatus 2 lifts up a cared person 400 lying on a bed 401 in this state and moves him to a bed 402 located in another location.

In FIG. 9, a carer first gives an operation input to the input portions 14 of the supporting apparatus 2 to bring the entire supporting apparatus 2 toward one side surface of the bed 401 on which the cared person 400 is lying (Step S2). Based on this operation input, the controller 110 causes the position driving devices 116 to rotate the moving portions 4, thereby bringing the entire supporting apparatus 2 toward the side surface of the bed 401 (Step S4).

At this time, as shown in FIG. 10A, the input-portion supporting portions 305 are positioned such that the input portions 14 are located above the lifting portions 16, and the leading ends of the lifting portions 16 are adjusted to such positions easy to see. Then, an operation instruction is inputted to the input portions 14. In this way, the carer can turn his eyes toward the leading ends of the lifting portions 16, wherefore the collision of the leading ends of the lifting portions 16 with the cared person can be prevented.

Subsequently, the carer places the leading ends of the lifting portions 16 at positions P1 near the side surface of the bed 401 and gives an operation input to move the lifting portions 16 to positions where the lifting portions 16 are inserted between the cared person 400 and the bed 401 (Step S6). Based on this operation input, the controller 110 instructs the joint driving devices 114 and the elevation driving devices 118 to operate the joint portions 13, 15 and the leg portions 18 (Step S8). It should be noted that the moving portions 4 may also be driven by the position driving devices 116 to adjust the position if necessary.

Upon giving the operation input, the input portions 14 are lowered from the upper side to the lower side of the lifting portions 16 as shown in FIG. 10A, thereby positioning the input-portion supporting portions 305 to the positions where it can be confirmed that the lifting portions 16 have been placed. Since the input portions 14 are operated with the carer's palms faced up at this time, the height positions of the lifting portions 16 and the placement of the lifting portions 16 on the bed 401 can be easily confirmed by the contact of the backs of the carer's hands with the bed 401. Accordingly, an operational error can be prevented. Although the input portions 14 are turned to right upon being lowered from the upper side to the lower side in FIG. 10A, the input portions may be turned to left so as to come closer to the cared person 400. In this way, the input portions 14 can be arranged more forward (toward the cared person 400) than the sliding portions 18, so that the carer's hands can touch the cared person 400 earlier than the sliding portions 18. By causing the carer's hands to touch the cared person 400 earlier than the sliding portions 18, the placing position and the inserting position can be easily positioned. Further, the carer can give a sense of security by touching the cared person 400 with his hands earlier than the sliding portions 18.

By rotating the input-portion supporting portions 305 to make the positions of the input portions 14 changeable in this way, physical burdens on the carer can be reduced, operational errors can be prevented and a sense of security can be given to the cared person.

Subsequently, the carer gives an input to the input portions 14 to move the sliding portions 18 forward (Step S10) after adjusting the leading ends of the lifting portions 16 to positions where the lifting portions 16 are inserted between the cared person 400 and the bed 401. At this time, the carer can insert the sliding portions 18 between the cared person 400 and the bed 401 in the same posture after confirming the positions of the leading ends of the lifting portions 16 and needs not stretch his arms. Therefore, the carer can scoop up the cared person 400 using the lifting portions 16 in a posture with less physical burden.

Based on this operation input, the controller 110 gives such an instruction to the belt driving motors 24a to turn the belt portions 23 of the sliding portions 18 in a direction opposite to the moving direction of the sliding portions 18 and substantially at the same speed as the moving speed of the sliding portions 18 (Step S12). Simultaneously or immediately thereafter, the controller 110 gives an instruction to the slide driving devices 32 to move the sliding portions 18 forward (Step S14). At this time, since the belt driving motors 24a are rotated to turn the belt portions 23 of the sliding portions 18 in the direction opposite to the moving direction of the sliding portions 18 and substantially at the same speed as the moving speed of the sliding portions 18, a relative speed of the cared person 400 and the belt portions 23 becomes substantially “0” and the belt portions 23 of the sliding portions 18 held in contact with the back of the cared person 400 do not rub against the cared person 400. Further, since the plurality of rollers 26b of the roller array 26 rotate on the bed 401 as the sliding portions 18 move, the sliding portions 18 can be easily inserted between the cared person 400 and the bed 401. At this time, if necessary, the controller 110 also instructs the joint driving devices 114, the elevation driving devices 118 and the position driving devices 116 to operate the joint portions 13, 15, the leg portions 8 and the moving portions 4.

Upon giving this operation input, the input portions 14 are positioned at the side above the lifting portions 16 as shown in FIG. 10B to locate the input-portion supporting portions 305 at such positions where the insertion of the sliding portions 18 is easy to confirm. Thus, an operational error can be prevented.

Subsequently, the carer gives an input to the input portions 14 to move the sliding portions 18 backward up to specified positions P3 where the cared person 400 and the input portions 14 do not touch each other, for example, as shown in FIG. 10C (Step S16) when the sliding portions 18 are sufficiently inserted between the cared person 400 and the bed 401 to reach the advanced positions, e.g. positions P2 where the leading ends of the lifting portions 16 can sufficiently scoop up the cared person 400 as shown in FIG. 10B. Here, the controller 110 temporarily stops the movements of the sliding portions 18 upon judging that the sliding portions 18 are at the positions P3 when the light receiving elements 38b receive lights from the light emitting elements 27.

Based on this operation input, the controller 110 stops the rotation of the belt driving motors 24a of the sliding portions 18 and instructs the belt driving motors 24a to stop rotating the belt portions 23 (Step S18). Simultaneously or immediately thereafter, the controller 110 gives an instruction to the slide driving devices 32 to slide the sliding portions 18 backward up to the positions P3 (Step S20). At this time, the sliding portions 18 can be withdrawn without rubbing against the bed 401 since the plurality of rollers 26b of the roller array 26 rotate on the bed 401 as the sliding portions 18 move.

It should be noted that the controller 110 executes such a control as to automatically stop the sliding portions 18 at the specified positions P1, P2 and P3 by receiving the lights from the light emitting elements 27 by the light receiving elements 38a, 38b and 38c to detect the positions of the sliding portions 18. For example, when the carer inputs an operation instruction such as an “insertion mode” for moving the sliding portions 18 from the positions P1 to the positions P2, a “withdrawal mode” for moving the sliding portions 18 from the positions P2 to the positions P3 or an “accommodation mode” for moving the sliding portions 18 from the positions P3 to the positions P1, the controller 110 executes a control to move or stop the sliding portions 18 to or at the specified positions P1, P2 or P3 in accordance with the inputted mode. Therefore, the carer can more easily operate the supporting apparatus 2.

Further, while the sliding portions 18 rest at the specified positions P3 as shown in FIG. 10C, the controller 110 causes the input position detectors 113 to detect the operating positions of the input portions 14 and judges whether or not the input portions 14 are located at such positions as not to touch the cared person 400. If the input portions 14 are located at such positions as not to touch the cared person 400, the sliding portions 18 are moved to the positions P1. This can prevent the contact of the input portions 14 and the cared person 400 and also prevent a possible injury of the cared person 400. On the other hand, if the input portions 14 are located at such positions as to touch the cared person 400, it might be notified to the carer by means of known notification means. The known notification means may be a sound generator, a display device or a vibrator.

Subsequently, the carer gives an operation input to the input portions 14 to lift up the cared person 400 (Step S22) when the sliding portions 18 are moved to and stopped at the positions P1 (retracted positions) as shown in FIG. 10D.

Based on this operation input, the controller 110 causes the elevation driving devices 188 to elevate the leg portions 8 to lift up the lifting portions 16 with the cared person 400 supported on the lifting portions 16 (Step S24).

Subsequently, the carer operates the input portions 14 as shown in FIG. 10E to give an input for moving the entire nursing robot system 1 toward a bed 402 as a transfer end (Step S26).

Based on this input, the controller 110 outputs an instruction to the position driving devices 116 to move the moving portions 4 up to a desired position (e.g. the position of the bed 402) (Step S28). Since the input portions 14 located at the leading end sides of the lifting portions 16 are operated with the carer's palms faced upward at this time, the carer's arms are located as if they were supporting the back of the cared person 400, whereby the cared person 400 feels as if he were held by the carer to have a sense of security.

Upon confirming the approach of the supporting apparatus 2 toward the lateral side of the bed 402, the carer gives an input to the input portions 14 to lower the lifting portions 16 onto the bed 402 (Step S30). Based on this input, the controller 110 instructs the joint driving devices 114 and the elevation driving devices 118 to operate the joint portions 13, 15 and the leg portions 8 in order to lower the lifting portions 16 bearing the cared person 400 onto the bed 402 (Step S32).

Upon giving the operation input, the input portions 14 are lowered to the side below the lifting portions 16 as shown in FIG. 10E, thereby positioning the input-portion supporting portions 305 to the positions where the placement of the lifting portions 16 can be confirmed.

Subsequently, after confirming that the lifting portions 16 bearing the cared person 400 have been placed on the bed 402, the carer gives an input to the input portions 14 to move the sliding portions 18 forward (Step S34).

Based on this input, the controller 110 instructs the slide driving devices 32 to slide the sliding portions 18 forward with the rotation of the belt portions 23 kept stopped (Step S36). At this time, since the rollers 26b of the sliding portions 18 move while rolling on the bed 402, the sliding portions 18 can be pushed without rubbing against the bed 402. Here, the controller 110 causes the sliding portions 18 to stop when the sliding portions 18 are moved forward up to the specified positions P3 where the cared person 400 and the input portions 14 do not touch each other as shown in FIG. 10F. Further, the controller 110 causes the sliding portions 18 to move to the specified positions P2 as shown in FIG. 10G when the positions of the input portions 14 are changed to upper sides. Here, the controller 110 causes the movements of the sliding portions 18 to be stopped, thereby hindering any further movements of the sliding portions 18 to left (direction of the arrow “a”) if lights from the light emitting elements 27 are received by the light receiving elements 38c. In this way, the controller 110 executes such a control that the sliding portions 18 can be moved within suitable ranges to support the cared person 400.

The carer gives an input to the input portions 14 to move the sliding portions 18 backward (Step S38) after confirming that the sliding portions 18 bearing the cared person 400 were moved to and stopped at the specified positions P2 on the bed 402.

Based on this input, the controller 110 instructs the belt driving motors 24a to turn the belt portions 23 in the direction opposite to the moving direction of the sliding portions 18 and substantially at the same speed as the moving speed of the sliding portions 18 (Step S40). Simultaneously or immediately thereafter, the controller 110 instructs the slide driving devices 32 to move the sliding portions 18 backward relative to the fixing portions 20 (Step S42). Since the belt portions 23 are turned in the direction opposite to the moving direction of the sliding portions 18 and substantially at the same speed as the moving speed of the sliding portions 18, a relative speed of the cared person 400 and the belt portions 23 becomes substantially “0” and the belt portions 23 of the sliding portions 18 held in contact with the back of the carer 400 do not rub against the cared person 400. Further, by letting the plurality of rollers 26b of the roller array 26 rotate on the bed 402 as the sliding portions 18 move, friction between the sliding portions 18 and the bed 402 is suppressed.

Further, the controller 110 judges that the sliding portions 18 were moved to the specified positions P1 and causes the sliding portions 18 to stop when the light receiving elements 38a receive the lights from the light emitting elements 27 as shown in FIG. 10H.

As described above, since the input portions 14 are arranged near the leading ends of the lifting portions 16 according to the supporting apparatus 2 of this embodiment, operation inputs can be given at positions where the leading ends of the lifting portions 16 can be easily confirmed. Thus, the carer can perform the inserting operation while carefully watching the leading ends of the lifting portions 16, thereby being able to prevent the collision of the leading ends of the lifting portions 16 with the cared person 400. The cared person 400 can feel as if he were held by the carer's arms and can have a sense of security.

Further, since the positions of the input portions 14 relative to the placing surfaces 19 can be changed in forward and backward directions, the positions of the input portions 14 can be changed to those where the carer can easily operate and burdens during a series of operations to hold the cared person up can be reduced. For example, if the sliding portions 18 are at the retracted positions and the input portions 14 are at the first positions as the front positions before the placing surfaces 19 are inserted underneath the cared person, the input portions 14 are located closer to the cared person as compared to the case where they are at the second positions, wherefore the carer can easily position the placing surfaces 19 on the bed and can detect the placement on the bed while griping the input portions 14. Accordingly, the operability of the supporting apparatus 2 can be improved and the operation of inserting the placing surfaces 19 underneath the cared person can be easily performed. On the other hand, if the input portions 14 are at the second positions (the sliding portions 18 are at the advanced positions) when the placing surfaces 19 are inserted underneath the cared person, the input portions 14 are located closer to the carer, wherefore the carer can hold the cared person without bending over forward, whereby the burden of the operation of holding the cared person can be reduced. Further, if the input portions 14 are at the first positions upon pulling the placing surfaces 19 toward the carer's chest after scooping up the cared person, the carer needs not excessively pull his elbows backward since the input portions 14 are not too close to the carer. Therefore, the burden during the operation of pulling the cared person closer and holding him can be reduced and the input portions 14 do not stand as a hindrance upon pulling the cared person closer. Since the carer can hold the cared person without being forced to take such a posture imposing burdens on him by displacing the input portions 14 relative to the placing surfaces 19 in this way, burdens of this series of operations can be reduced.

Further, since the operating positions of the input portions 14 can be changed to the same height as the lower surfaces of the lifting portions 16 in this embodiment, the backs of the carer's hands can come into contact with the bed, whereby the placement of the lifting portions 16 on the bed or the like can be easily confirmed to prevent an operational error. Therefore, physical burdens on the carer can be reduced, operational errors can be prevented and a sense of security can be given to the cared person 400.

Since the sliding portions 18 are moved forward and backward to scoop up the cared person 400 after the leading ends of the lifting portions 16 are moved to positions right before the back side of the cared person 400 in this embodiment, the carer can hold the cared person 400 without taking such a posture imposing physical burdens such as low back pain on him.

Further, since the input portions 14 can be displaced toward the lower sides of the lifting portions 16 in this embodiment, the contact of the input portions 14 with the cared person can be prevented when the sliding portions 18 bearing the cared person are moved backward. Therefore, a sense of security can be given to the carer.

In this embodiment, if the input portions 14 are at the first positions, the carer can touch the cared person while gripping the input portions 14 before the placing surfaces 19 touch the cared person. In other words, the carer can first touch the cared person. Therefore, a sense of security can be given to the carer.

Since the input portions 14 are rotatably supported on the input-portion supporting portions 305 in this embodiment, the positions of the input portions 14 relative to the placing surfaces 19 can be changed. Therefore, the relative positions of the input portions 14 can be changed by one operation.

Further, since the input-portion supporting portions 305 are U-shaped levers in this embodiment, the input portions 14 can be easily operated with the thumbs to give an input if the input portions 14 are gripped with the palms faced upward. Further, the placement of the lifting portions 16 can be confirmed by the backs of the hands while the input portions 14 are operated.

In this embodiment, the sliding portions 18 are slid relative to the fixing portions 20 to change the positions of the input portions 14 relative to the placing surfaces 19, whereby the input portions 14 can be located at the first positions and the second positions. Further, even if the length of the arm portions 12 supporting the lifting portions 16 is short and the forward and backward strokes of the lifting portions 16 are restricted upon scooping up the cared person using the lifting portions 16, the sliding portions 18 can be extended from the leading ends of the lifting portions 16 and can be easily inserted between the cared person and the bed. In other words, the system can be miniaturized by shortening the length of the arm portions 12.

Further, since the sliding portions 18 are controlled to be movable within the specified range based on the position information of the sliding portions 18 in this embodiment, it is possible to stop the sliding portions 18 at positions where the carer can easily scoop up the cared person and to lift up the cared person. Therefore, no physical burdens are imposed on the carer and a sense of security can be given to the cared person. Further, the sliding portions 18 can be extended and retracted within a safe range.

Since the sliding portions 18 include the belt portions (endless belts) 23 in this embodiment, the cared person can be moved onto the upper surfaces of the sliding portions 18 by the driving of the belt portions 23 in addition to the sliding of the sliding portions 18. Thus, the cared person can be easily transferred to and from the lifting portions.

Further, since a relative speed of the upper surface of the belt portion 23 and the cared person at a contact part is substantially zero in this embodiment, there is no likelihood that the upper surface of the belt portion 23 rubs against the cared person when the sliding portion 18 is inserted and withdrawn between the cared person and the bed. Therefore, a sense of security can be given to the cared person without exerting unnecessary forces to the cared person.

Further, since the roller arrays 26 are arranged on the lower surfaces of the sliding portions 18 in this embodiment, the sliding portions 18 and the bed do not rub against each other when the sliding portions 18 are inserted and withdrawn between the cared person and the bed. Thus, there is no likelihood of rumpling the bed as the sliding portions 18 are moved, and the sliding portions 18 can be smoothly inserted and withdrawn.

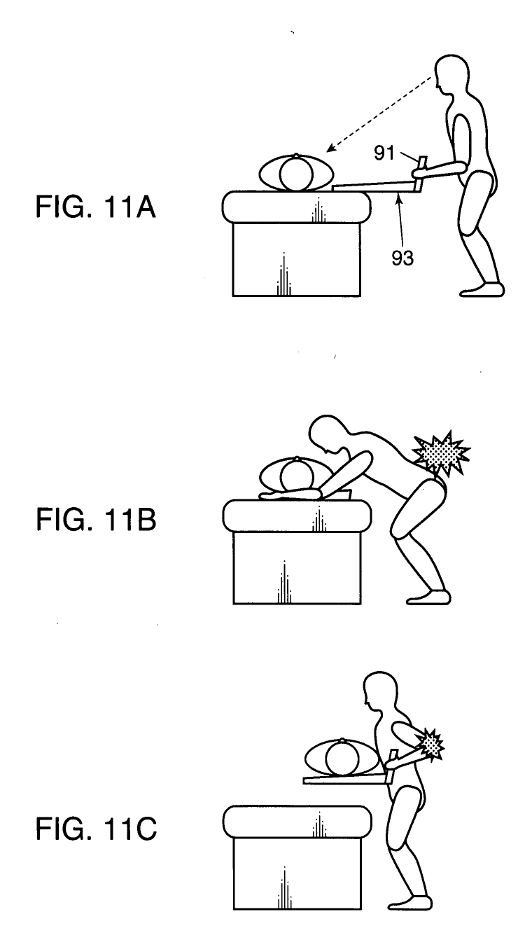

On the other hand, if input portions 91 are arranged at the rear ends of conventional lifting portions 93, it is difficult to confirm the placement of the lifting portions 93 and to position the lifting portions 93 as shown in FIG. 11A. It is also difficult for the carer to first touch the cared person with the hands gripping the input portions 91.

If the input portions 91 are arranged at the front ends of the conventional lifting portions 93, the carer bends over forward upon holding the cared person as shown in FIG. 11B, thereby having a large burden.

Further, if the input portions 91 are arranged at the rear ends of the conventional lifting portions 93, the carer needs excessively pull the elbows backward upon pulling the placing surfaces 19 closer after scooping up the cared person. The burden of the carer is also large at this time.

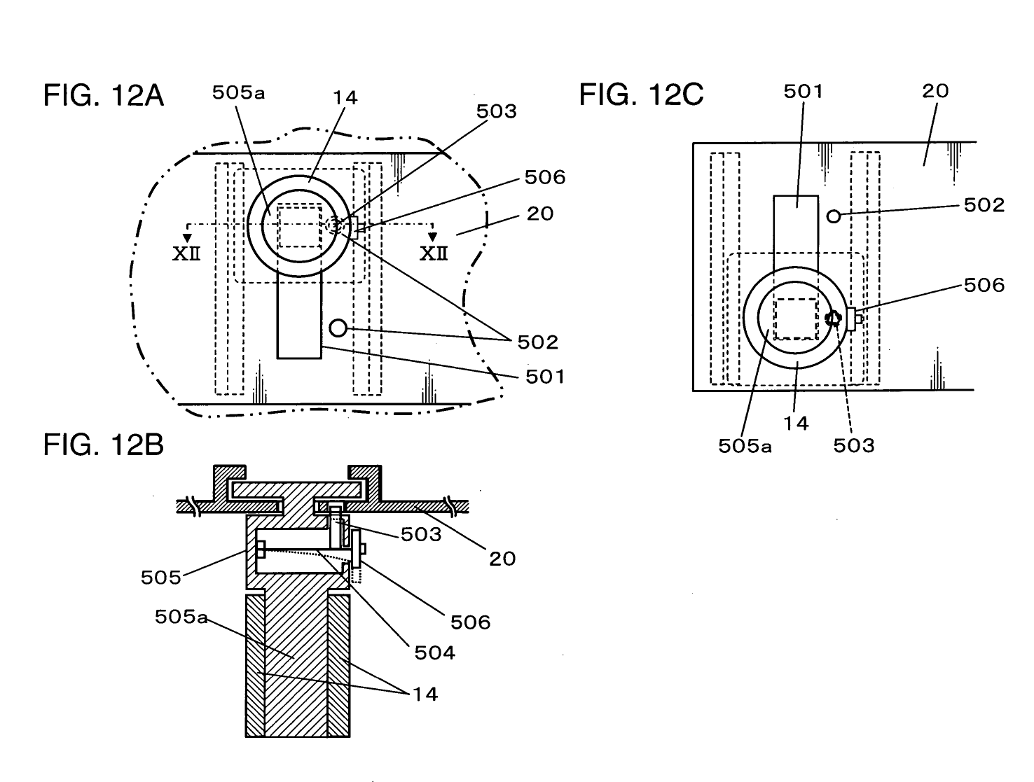

Although the positions of the input portions 14 are made changeable by rotating the input-portion supporting portions 305 in this embodiment, the present invention is not limited to this construction. For example, the input portions 14 may be slidably connected with the fixing portions 20. By such a construction as well, the positions of the input portions 14 can be changed. An example of this case is described with reference to FIGS. 12A, 12B and 12C. FIG. 12A is a side view of an essential part of an input-portion supporting portion 505, FIG. 12B is a section along XII-XII of FIG. 12A and FIG. 12C is a side view of the essential part showing a state where the input-portion supporting portion 505 is lowered.

As shown in FIG. 12B, the input portion 14 is supported by the input-portion supporting portion 505. The fixing portion 20 is formed with a vertically long opening 501, and the input-portion supporting portion 505 vertically moves along the opening 501. Further, the fixing portion 20 is formed with two holes 502 vertically spaced apart from each other. These holes 502 are for positioning. The input-portion supporting portion 505 is fixed in position in vertical direction by the positioning pin 503. Specifically, a positioning pin 503 is pressed by a leaf spring 504 to be inserted into the hole 502, whereby the position of the input-portion supporting portion 505 is fixed.

Upon moving the input-portion supporting portion 505, a switch 506 is moved in a direction away from the fixing portion 20 to retract the positioning pin 503 secured by the leaf spring 504 from the hole 502. In this way, the input-portion supporting portion 505 can be vertically moved. By returning the switch 506 when the input-portion supporting portion 505 is moved to the position of another hole 502, the positioning pin 503 is inserted into this another hole 502. In this way, the input-portion supporting portion 505 can be fixed with the height thereof changed.

Although the sliding direction is a vertical direction, it may be forward and backward directions or an oblique direction. Further, the leaf spring 504 may be a spring. The aforementioned rotary arm 132 or the U-shaped lever may be constructed to be slidable. h

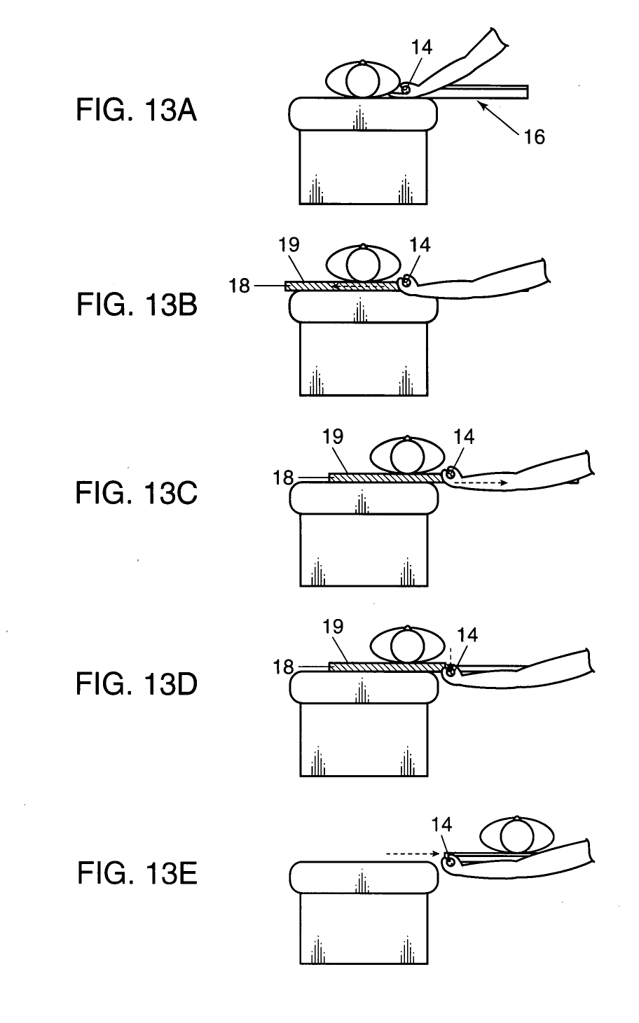

Here, an operation of holding the cared person by means of the lifting portions 16 in which the input-portion supporting portions 505 are vertically movable is described with reference to FIGS. 13a to 13E. The input portions 14 are set at the upper positions (see FIGS. 13A and 13B) upon inserting the sliding portions 18 underneath the cared person. At this time, the input-portion supporting portions 505 are inserted in the upper holes 502. The entire lifting portions 16 bearing the cared person are moved backward with the sliding portions 18 held at the advanced positions (see FIG. 13C). Since the input portions 14 cannot be moved to the lower positions if the input portions 14 are on the bed at this time, the input portions 14 are slid while being held at the upper positions and are lowered to the lower positions (see FIG. 13D) when being moved away from the bed. At this time, the input-portion supporting portions 505 are inserted into the lower holes 502. Then, the sliding portions 18 are moved backward to the retracted positions (see FIG. 13E). In this way, the cared person can be pulled closer without touching the input portions 14.

As shown in FIGS. 12A and 12B, the input portion 14 may be made attachable to and detachable from the input-portion supporting portion 505 by conforming the inner diameter of the input portion 14 having a tubular shape with the outer diameter of a leading end part 505a of the input-portion supporting portion 505 having a cylindrical shape. Thus, the carer can utilize the input portions 14 detached from the fixing portions 20, and can operate the input portions 14 at safe positions with less burden. For example, the cared person detaches the input portions 14 from the input-portion supporting portions 505 and operates the input portions 14 from behind the lifting portions 16 when narrowing the spacing between the pair of lifting portions 16 after scooping up the cared person. Thus, there is no likelihood of being jammed by the pair of lifting portions 16.

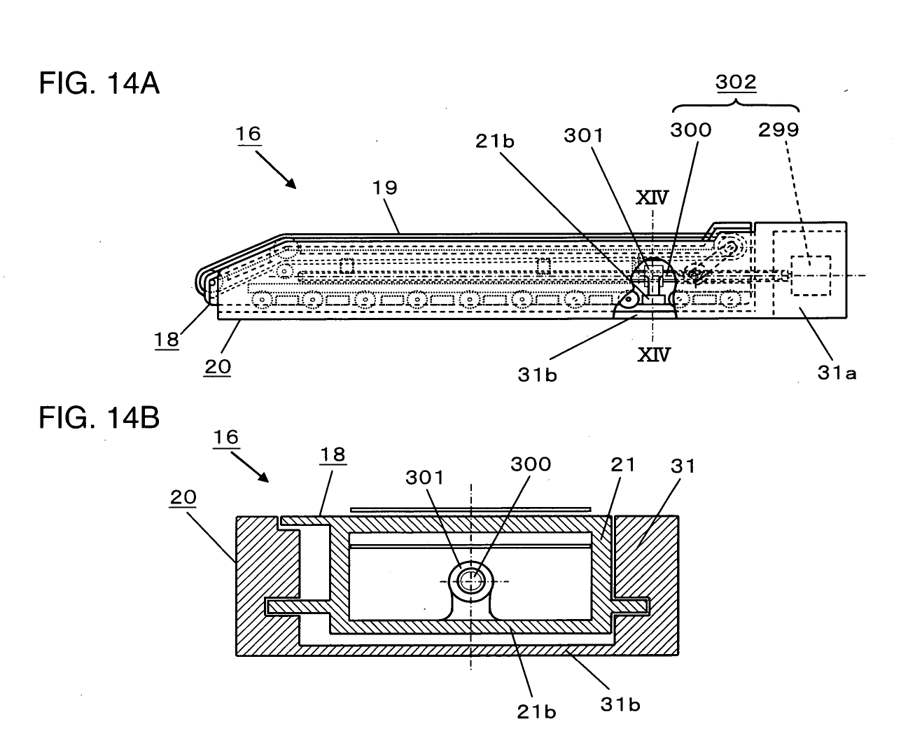

Although the construction utilizing the rack gear 21g and the pinion gear 35 is shown as means for moving the sliding portion 18 of the lifting portion 16 in this embodiment, the present invention is not limited to this construction. Another example of the slide driving device 32 is described with reference to FIGS. 14A and 14B. FIG. 14A is a side view of the other example of the slide driving device and FIG. 14B is a section along XIV-XIV of FIG. 14A.

As shown in FIGS. 14A and 14B, a slide driving device 302 includes a screw driving motor 299 provided in a connecting portion 31a of the fixing portion 20, and a ball screw shaft 300 secured to the rotary shaft of the screw driving motor 299. The ball screw shaft 300 is engaged with a nut 301 secured to the bottom surface portion 21b of the slide frame portion 21 of the sliding portion 18. Even with such a construction, the sliding portion 18 can be moved forward and backward relative to the fixing portion 20, and the screw driving device 302 can be arranged in the fixing portion 20. It should be noted that the screw used in this construction is not limited to the ball screw, and may be a triangular screw or trapezoidal screw.

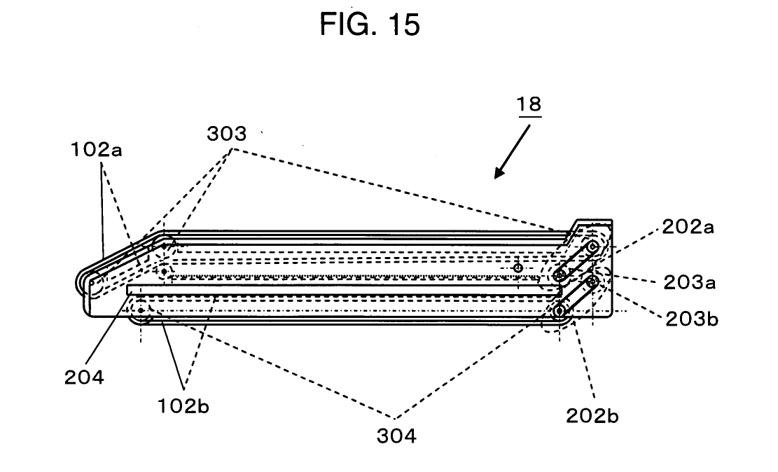

In this embodiment, the roller array 26 including the plurality of rollers 26b, which are free rollers, is provided as shown in FIGS. 6, 7A and 7B to prevent the sliding portion 18 and the bed from rubbing against each other upon inserting the sliding portion 18 underneath the cared person. However, the present invention is not limited to this. Another example of the sliding portion 18 is described with reference to FIG. 15. FIG. 15 is a side view of the sliding portion 18.

As shown in FIG. 15, the sliding portion 18 includes rollers 303 disposed in an upper part, a belt portion 102 mounted on the rollers 303, rollers 304 disposed in a lower part of the sliding portion 18, a lower belt portion 102b mounted on the rollers 304, belt driving motors 203a, 203b for rotating the rollers 303, 304 and turning the belt portion 102a and the lower belt portion 102b via belt driving mechanism portions 202a, 202b. The rollers and the belts are rotated and turned as the sliding portions 18 are moved forward and backward.

In the case of such a construction, the controller 110 causes the belt driving motors 203a, 203b to rotate such that the moving directions of the upper halves of the belt portions 102a and the lower halves of the lower belt portions 102b are respectively opposite to the moving direction of the sliding porticos 18 as the sliding portions 18 are inserted or withdrawn between the cared person and the bed, and controls the rotating speeds of the belt driving motors 203a, 203b so that the belt portions 102a and the lower belt portions 102b move substantially at the same speed as the moving speed of the sliding portions 18. Further, when the sliding portions 18 are moving while bearing the cared person, the controller 110 controls the rotating speed of the belt driving motors 203b so that the rotation of the belt driving motors 203a for driving the belt portions 102a is stopped to stop the movements of the belt portions 102a, and only the lower belt portions 102b move as the sliding portions 18 are moved similar to the inserting or withdrawing operation.

Even with such a construction, the sliding portions 18 can be moved without rubbing against the cared person and the bed upon being inserted underneath the cared person or withdrawn from the underneath of the cared person.

Although the construction using the roller arrays 26 on the lower surfaces of the sliding portions 18 is shown in FIGS. 6, 7A and 7B, the lower belt portions 102b may be used as shown in FIG. 15. Further, the rollers 304 may be directly driven by motors inside the sliding portions 18. This enables the sliding portions 18 to autonomously move in the case of being detached from the fixing portions 20.

In the case of such a construction, guide rails 204 provided in the sliding portions 18 are guided by recessed grooves formed in the fixing portions 20 at the time of accommodating the sliding portions 18 into the fixing portions 20. Further, by causing fixing pins to project from the fixing portions 20 and inserting them into holes formed in the sliding portions 18 when the accommodation of the sliding portions 18 is completed, a known locking mechanism is actuated to prevent the detachment of the sliding portions 18 from the fixing portions 20, e.g. by fixing the sliding portions 18 to the fixing portions 20. This can prevent the sliding portions 18 from being detached while the sliding portions 18 are moving with the cared person carried thereon. A fixing method may be such that the sliding portions 18 are pressed by the fixing portions 20 by means of elastic members such as leaf springs, springs or rubber.

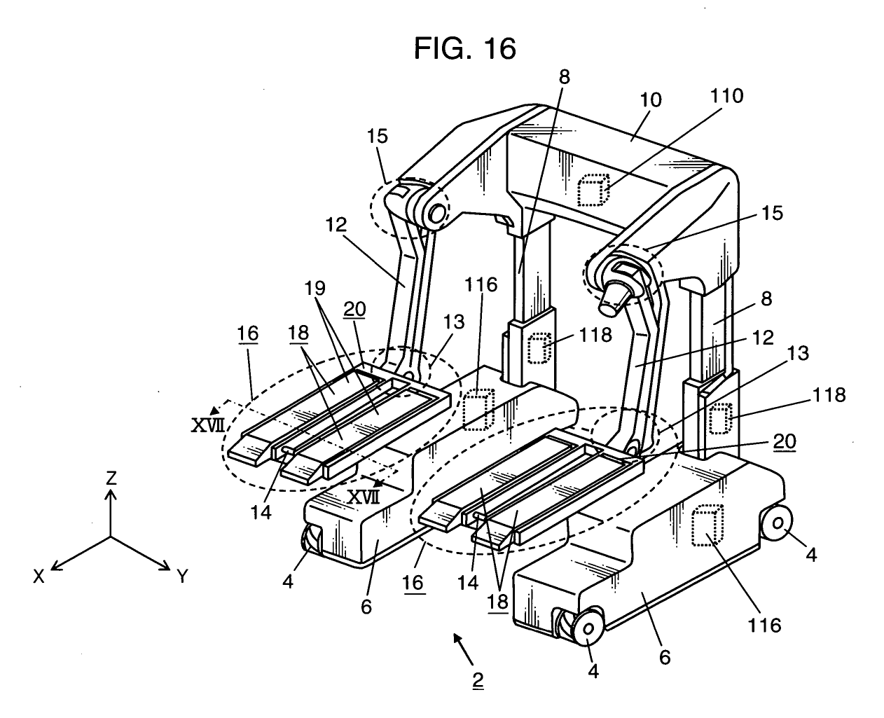

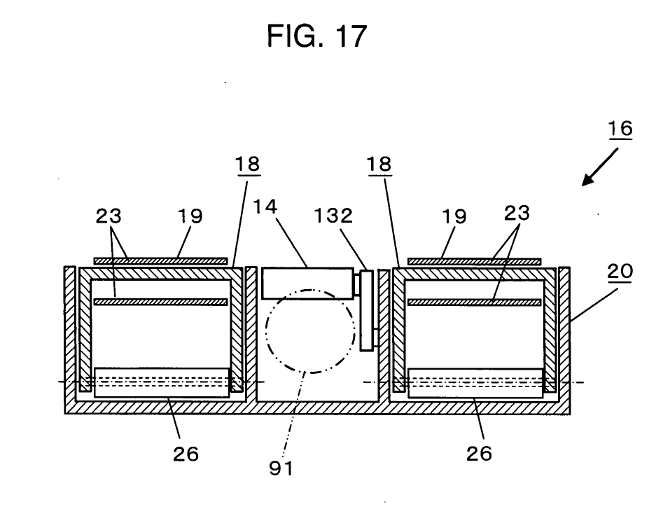

Although the lifting portions 16 are arranged at the outer sides of the carer's arms as shown in FIGS. 1 and 2, the present invention is not limited thereto. For example, each lifting portion 16 may be arranged at the opposite sides of each of the carer's arms. This construction is described with reference to FIGS. 16 and 17. FIG. 16 is a perspective view of a nursing robot system and FIG. 17 is a section along XVII-XVII of FIG. 16.

As shown in FIGS. 16 and 17, each lifting portion 16 includes a pair of sliding portions 18, which are spaced apart in the width direction of the carer to define such a clearance as to enable the entrance of a human arm. The input portion 14 is disposed in this clearance. The sliding portions 18 are arranged to be located at the opposite sides of each of the carer's both arms, and the input portions 14 are operated by inserting each arm between the two sliding portions 18.

By such a construction, the carer can support the cared person at the opposite sides of each arm by means of the pair of sliding portions 18, whereby a holding area can be increased. Thus, the cared person can be stably held. Further, since the carer's arms can touch the cared person, the cared person can be directly supported by the carer's arms in the case of an emergency such as a fall of the cared person, whereby safety can be improved. Further, a better sense of security can be given to the cared person.

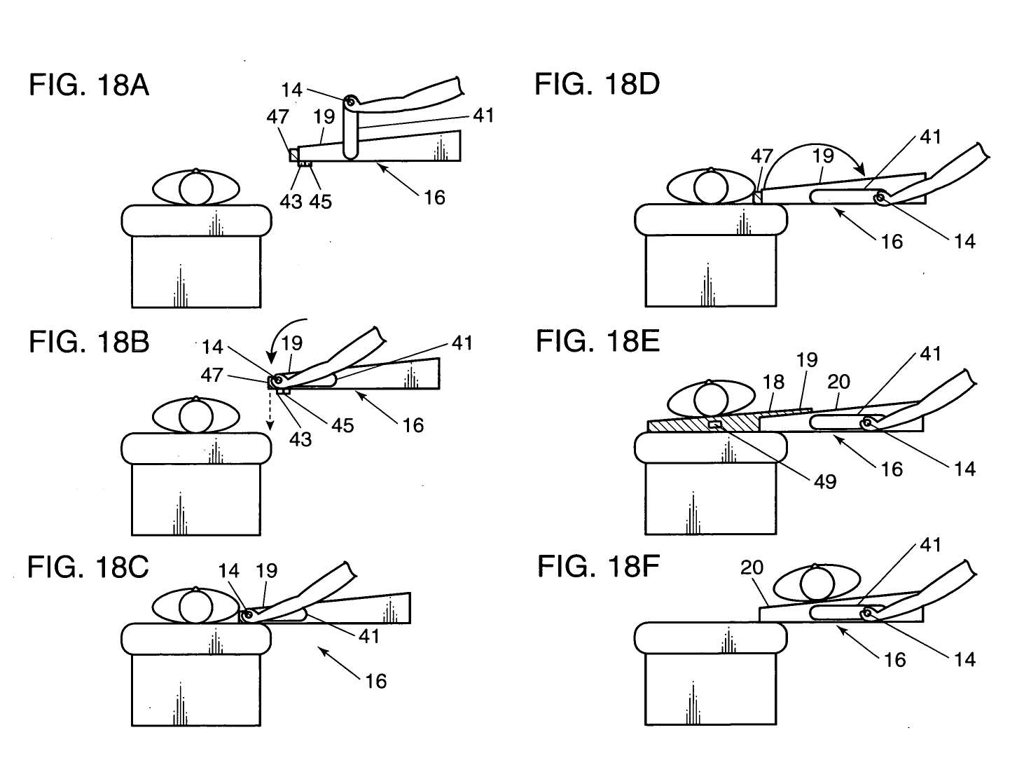

Although the carer changes the positions of the input portions 14 himself in this embodiment, the input portions 14 may automatically change the positions thereof. A case where the supporting portions for the input portions 14 are in the form of operation levers 41 rotatable relative to the fixing portions 20, for example, as shown in FIG. 18A to 18F is described.

Three sensors are disposed at the leading end of each lifting portion 16. A first sensor 43 is a distance sensor capable of detecting whether or not there is any object within a specified range, and is used to detect the presence or absence of the bed below the leading end of the lifting portion 16. A second sensor 45 is a sensor capable of detecting whether or not the lower side of the leading end of the lifting portion 16 is in contact with the bed and is used to detect whether or not the leading end of the lifting portion 16 has been placed on the bed. A third sensor 47 is a sensor capable of detecting whether or not the leading end of the lifting portion 16 is in contact with the cared person and is used to detect whether or not the leading end of the lifting portion 16 placed on the bed has come into contact with the cared person.

The sliding portion 18 includes a sensor (fourth sensor) 49 capable of detecting a load. This fourth sensor 49 is used to detect whether or not the cared person is on the sliding portion 18.

The controller 110 causes the operation levers 41 to rotate, thereby locating the input portions 14 at the leading ends of the lifting portions 16 (see FIGS. 18A and 18B) when the presence of the bed below the leading ends of the lifting portions 16 is detected by the first sensors 43. Since the input portions 14 are located at the front positions in this way, an operation burden can be reduced in an operation of setting the leading ends of the lifting portions 16 on the bed. In other words, it can be easily performed to adjust the heights of the lifting portions 16 and set the lifting portions 16 on the bed by moving the input portions 14 toward the leading ends of the lifting portions 16.

Subsequently, when the lifting portions are placed on the bed (FIG. 18C), the placement on the bed is detected by the second sensor 45 and the contact of the leading ends of the lifting portions 16 with the cared person is detected by the third sensors 47, the controller 110 causes the operation lever 41 to be rotated in a reverse direction this time to move the input portions 14 to the back positions (FIG. 18D). Thus, even when the sliding portions 18 are inserted underneath the cared person, the carer needs not bend over forward. When the sliding portions 18 are moved forward (FIG. 18E) and the weight of the cared person is detected as a load by the fourth sensors 49, the controller 110 causes the sliding portions 18 to move backward (FIG. 18F).

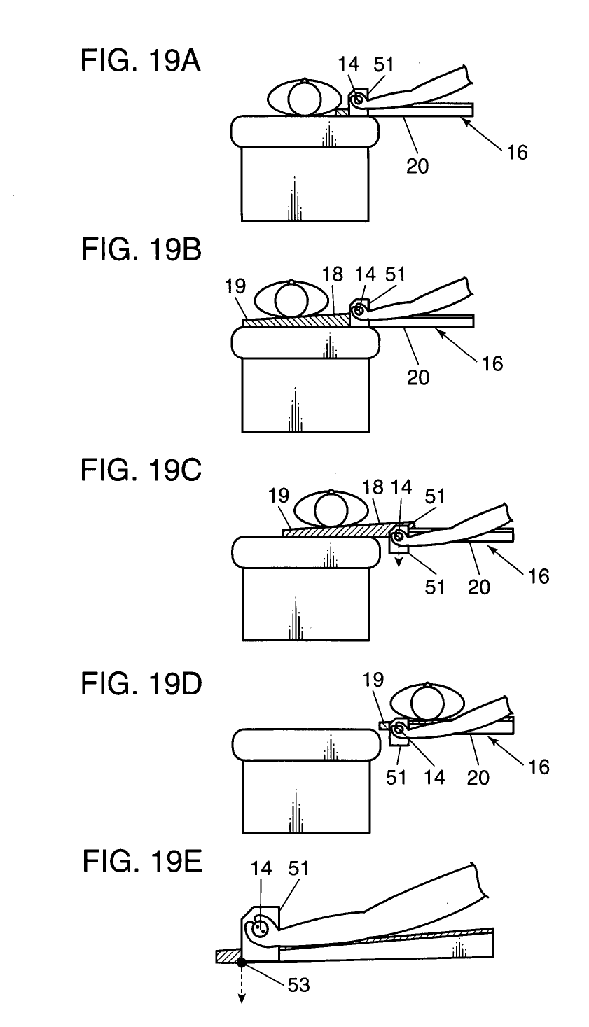

FIGS. 19A to 19E are diagrams showing an example in which the input-portion supporting portion are in the form of operation levers 51 vertically movable relative to the fixing portions 20. A sensor 53 is disposed on the lower surface of each operation lever 51. This sensor 53 is capable of detecting whether or not there is any object on the lower surface of the operation lever 51 and used to detect whether or not the operation lever 51 is on the bed.

When the sliding portions 18 are moved backward after being moved forward relative to the fixing portions 20 of the lifting portions 16 placed on the bed (FIGS. 19A and 19B), the controller 110 causes the operation levers 51 to be kept at upper positions and the sliding portions 18 to be kept at the advanced positions while the bed is being detected by the sensor 53. In other words, the input portions 14 are kept at the second positions.

When the bed is no longer detected by the sensor 53, the controller 110 causes the operation levers 51 to be moved downward (FIG. 19D). Then, the controller 110 causes the sliding portions 18 to be moved backward on the condition that the operation levers 51 are set at lower positions. This mode can prevent the input portions 14 from moving downward despite the presence of the bed. On the other hand, the input portions 14 are automatically moved downward (retracted) if the bed is absent below the operation levers 51, whereby the contact of the input portions 14 or the operation levers 51 with the cared person can be reliably prevented even if the carer cannot afford to operate the input portions 14.

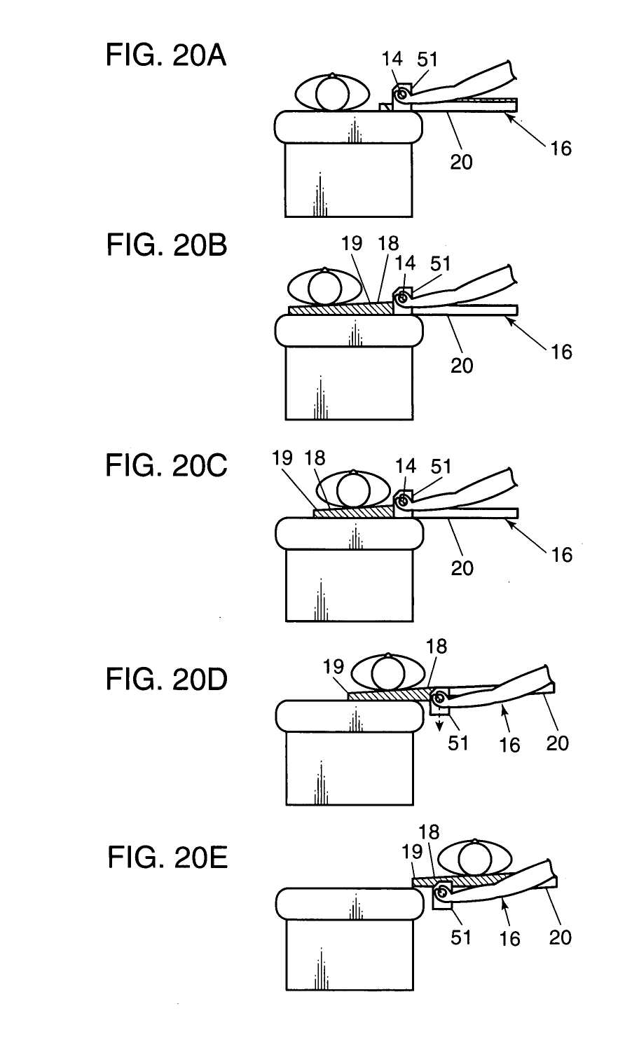

Although the lifting portions 16 are entirely pulled at first without moving the sliding portions 18 backward in FIGS. 19A to 19D when the lifting portions 16 bearing the cared person is pulled closer, FIGS. 20A to 20E shows an example in which the sliding portions 18 are moved backward at first upon pulling the lifting portions 16 bearing the cared person closer. In this case, backward movements of the sliding portions 18 are stopped before contact positions in order to prevent the contact of the cared person with the input portions 14 or the operation levers 51 as the sliding portions 18 are moved backward.

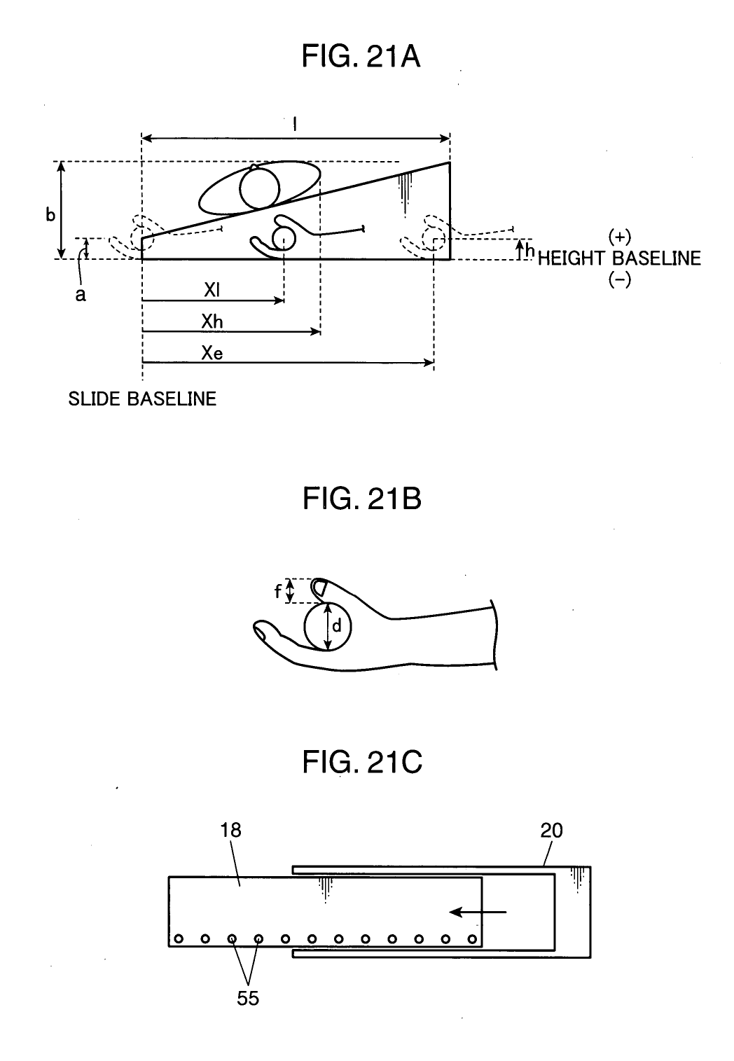

FIGS. 21A to 21C are diagrams showing characteristic values necessary to calculate the contact position of the cared person and the operation lever 51. It is assumed that 1 denotes the entire length of the sliding portion 18, “a” the thickness of the leading end of the sliding portion 18, “b” the thickness of the base end of the sliding portion 18, “h” the height of the operation lever 51, “d” the thickness of the operation lever 51, “of” the thickness of the carer's thumb, and “k” safety factor of “f” (where k>0). The height “h” of the operation lever 51 is (+) above the lower surface of the lifting portion 16 and (−) below it. It is further assumed that Xl, Xh and Xe denote distances from the leading end of the sliding portion 18 to the operation lever 51, to the back end of the cared person and to the operation lever 51 at a maximum sliding stroke (advanced position). The back end of the cared person can be detected by a multitude of sensors 55 arranged at intervals in longitudinal direction on the upper surface of the sliding portion 18, for example, as shown in FIG. 21C. The distance Xh is zero when the cared person is absent.

The controller 110 judges the contact based on whether or not the distance Xh from the leading end of the sliding portion 18 to the back end of the cared person is larger than the distance Xl from the leading end of the sliding portion 18 to the operation lever 51 when the height position of the operation lever 51 and the fingers is equal to or above the thickness “a” of the leading end of the sliding portion 18 and equal to or below the thickness “b” of the base end of the sliding portion 18.

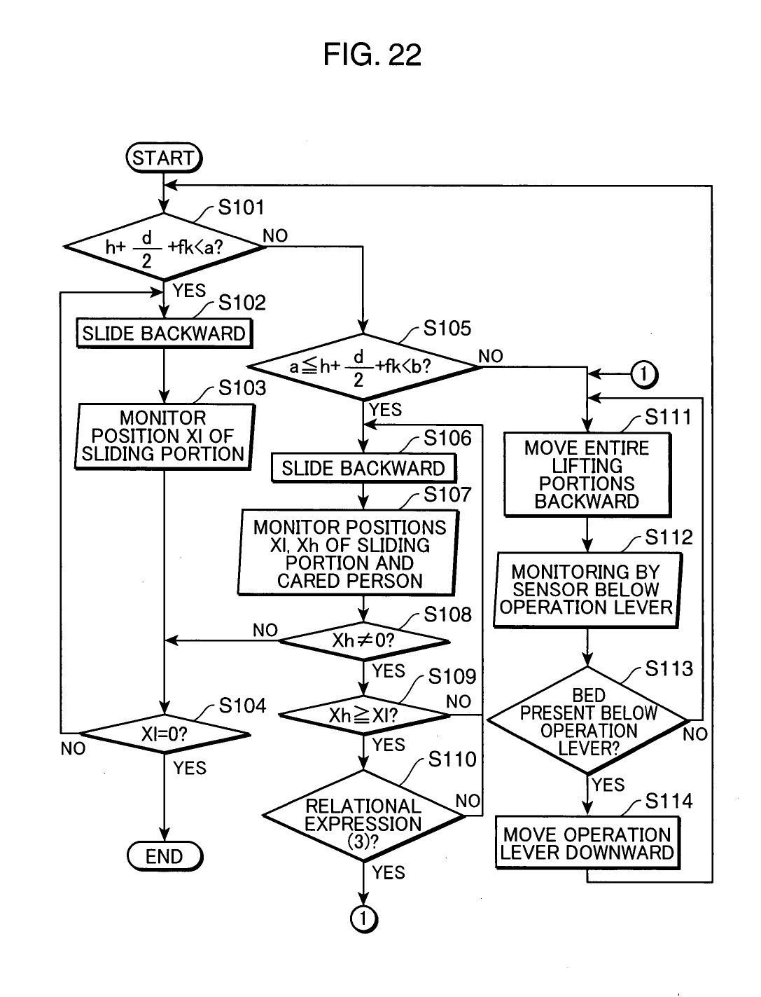

Specifically, as shown in FIG. 22, the controller 110 first judges whether or not the height positions of the operation levers 51 and the fingers are smaller than the thickness “a” of the leading ends of the sliding portions 18 (Step S101). This judgment is made based on the following relational expression (1):
h+d/2+f·k<a (1)
If YES is judged, the sliding portions 18 are moved backward (Step S102) and continues to be moved (Steps S103, S104) while being monitored until reaching the retracted positions (Xl=0).

On the other hand, if NO is judged in Step S101, Step S105 follows. In Step S105, it is judged whether or not the height positions of the operation levers 51 and the fingers lie within a specified range. Here, judgment is made based on the following relational expression (2):

$$a \leq h + \frac{d}{2} + f \cdot k < b \qquad ( 2 )$$

If YES is judged, the sliding portions 18 are moved backward (Step S106), and the rear end position Xh of the cared person and the position Xl of the operation levers 51 are monitored (Step S107). At this time, the cared person moves closer to the operation levers 51 as shown in FIG. 20C.

It is then confirmed whether or not the cared person is on the sliding portions 18 (Step S108), and the position Xh of the rear end of the cared person and the position Xl of the operation levers 51 are compared (Step S109) if the cared person is on the sliding portions 18. This routine returns to Step S106 and sliding portions 18 continue to be moved backward if the distance Xh is shorter than the distance Xl. Step S110 follows if the distance Xh becomes equal to or larger than the distance Xl.

In Step S110, judgment on the contact of the cared person and the operation levers 51 or the fingers is made based on the following relational expression (3):

$$a + \frac{b - a}{l} \cdot Xl \leq h + \frac{d}{2} + f \cdot k \qquad ( 3 )$$

If this relational expression (3) is satisfied, the sliding portions 18 are stopped and Step S111 follows, assuming that the cared person is in contact with the operation levers 51 or the fingers of the carer. It should be noted that Step S111 also follows if the judgment result of Step S105 is negative.

In Step S111, the lifting portions 16 themselves are moved backward without moving the sliding portions 18 backward. The presence or absence of the bed is monitored by the sensors at the bottoms of the operation levers 51 (Step S112). At this time, the presence or absence of the bed below the operation levers 51 is judged (Step S113). If the lifting portions 16 are moved backward until the bed is no longer present below the operation levers 51, the operation levers 51 are moved downward as shown in FIG. 20D (Step S114). Thus, the carer can pull the cared person closer without the cared person being held in contact with the operation levers 51 or the carer's fingers.

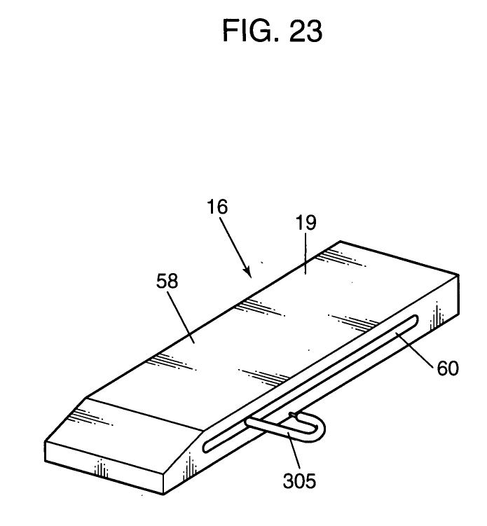

Although each lifting portion 16 includes the fixing portion 20 and the sliding portion 18 in the above embodiments, the present invention is not limited thereto. For example, a lifting portion 16 shown in FIG. 23 includes a lifting portion main body 58 having a box shape long in forward and backward directions without including the sliding portion. This lifting portion main body 58 is tapered toward the leading end at one end portion thereof. The upper surface of the lifting portion main body 58 serves as a placing surface 19 on which the cared person can be placed.

The input-portion supporting portion 305 supporting the input portion 14 is so supported in the lifting portion main body 58 as to be movable in forward and backward directions. The lifting portion main body 58 is formed with an oblong hole 60 extending in forward and backward directions. The input-portion supporting portion 305 is inserted into the oblong hole 60 and coupled to a driving mechanism accommodated in the main body 58. The input-portion supporting portion 305 is rotatable, wherein the input portion 14 can be located at a front position, a back position, an upper position and a lower position.

A movable amount of the input-portion supporting portion 305 is about the same as the sliding amount of the sliding portion 18. The input portion 14 is at a first position when the input-portion supporting portion 305 is at a front end position and the input portion 14 is at the front position. Accordingly, the first position is set such that the fingers of the carer's hand gripping the input-portion supporting portion 305 reach the cared person in this state. On the other hand, the input portion 14 is at a second position when the input-portion supporting portion 305 is at a rear end position. Also in the case of such a construction, effects similar to those of the lifting portion 16 including the sliding portion 18 can be obtained.

The input-portion supporting portion 305 may be constructed to be manually or automatically movable. In the case of constructing the input-portion supporting portion 305 to be automatically movable, it may be constructed in accordance with FIGS. 18 to 22. In the case of constructing the input-portion supporting portion 305 to be manually movable, the driving mechanism may be provided with a clutch, whereby the input-portion supporting portion 305 can be switched to a movable state and an immovable state.

The input-portion supporting portion may be constructed to be rotatable as well as vertically movable or may be constructed to be neither rotatable nor vertical movable.

Here, the first position is preferably located within a range where the fingers of a carer's hand gripping the input portion reach the cared person. In this mode, if the input portion is held at the first position upon inserting the placing surface underneath the cared person, the carer can touch the cared person with his hand while gripping the input portion before the placing surface touches the cared person. In other words, the carer can first touch the cared person. Therefore, a sense of security can be given to the cared person.

The input portion is preferably vertically displaceable relative to the placing surface. In this mode, if the input portion is held at a lower position upon pulling the placing surface closer after scooping up the cared person, the contact of the cared person with the input portion can be prevented.

The supporting apparatus preferably further comprises an input-portion supporting portion rotatably supporting the input portion. In this mode, the position of the input portion relative to the placing surface can be changed by rotating the input-portion supporting portion. Therefore, the relative position of the input portion can be changed by one operation.

The input-portion supporting portion may be a U-shaped lever and the input portion may be disposed at an end portion of the lever. In this mode, an input operation can be easily performed with the thumb if the input portion is gripped with the palm of the hand faced upward. Further, the placement of the supporting apparatus can be confirmed with the back of the hand while performing the operation by means of the input portion.

The supporting apparatus preferably further comprises a fixing portion including an input-portion supporting portion supporting the input portion, and a sliding portion having the placing surface and slidable relative to the fixing portion. In this mode, the position of the input portion relative to the placing surface can be changed by sliding the sliding portion relative to the fixing portion, whereby the input portion can be located at the first and second positions.

A plurality of fixing portions may be provided, the sliding portion may be slidably provided for each of the fixing portions, and the respective sliding portions may be independently slidable. In this mode, even if the cared person is lying in an oblique posture on the bed, the positions of the placing surfaces can be independently adjusted by sliding amounts of the sliding portions after the positions of the fixing portions are adjusted. Thus, the cared person can be easily transferred to the placing surface in accordance with the posture of the cared person lying on the bed or the like such as an oblique posture. Further, the cared person can be laid to optimize the posture or position so as not to lie obliquely to the bed upon being moved to another bed.

It is preferable that the supporting apparatus further comprises a slide driving device for sliding the sliding portion, a moving position detector for detecting position information of the sliding portion, and a controller for controlling the slide driving device; and that the controller executes such a control based on the position information of the sliding portion that the sliding portion is movable within a specified range. In this mode, the sliding portion can be stopped at such a position where the carer can easily scoop up the cared person, and can lift up the cared person. Thus, a sense of security can be given to the cared person without imposing any substantial physical burdens on the carer. Further, the sliding portion can be inserted and withdrawn within a safe range.

An input position detector for detecting operating position information of the input portion may be further provided, and the controller may execute such a control as to stop or move the sliding portion based on the position information of the sliding portion and the operating position information of the input portion. This mode can prevent the contact of the input portion with the cared person due to the movement of the sliding portion.

The sliding portion may include an endless belt, and the placing surface is formed by the upper surface of the endless belt. In this mode, the cared person can be transferred onto the upper surface of the sliding portion by the driving of the endless belt in addition to the sliding of the sliding portion, wherefore the cared person can be easily transferred to and from an upper surface of the sliding portion.

The upper surface of the endless belt is preferably moved in a direction opposite to a moving direction of the sliding portion and substantially at the same speed as a sliding speed of the sliding portion. In this mode, since a relative speed of the upper surface of the endless belt and the cared person at a contact part is substantially zero, there is no likelihood that the upper surface of the endless belt rubs against the cared person when the sliding portion is inserted and withdrawn between the cared person and the bed. Therefore, a sense of security can be given to the cared person without exerting unnecessary forces to the cared person.

A rotatable roller array may be further provided at the bottom side of the sliding portion. In this mode, the sliding portion and the bed do not rub against each other when the sliding portion is inserted and withdrawn between the cared person and the bed. Therefore, the sliding portion can be smoothly inserted and withdrawn without rumpling the bed.

A lower conveyor portion including a rotatable endless belt may be further provided at the bottom side of the sliding portion. In this mode, there is no sliding between the sliding portion and the bed by rotating the lower conveyor portion, wherefore the sliding portion can be smoothly moved.

Preferably, the lower conveyor portion drives the endless belt such that the lower surface of the endless belt moves in a direction opposite to a moving direction of the sliding portion and substantially at the same speed as a sliding speed of the sliding portion. In this mode, since a relative speed of the lower surface of the endless belt and the bed at a contact part can be substantially zero, there is no likelihood that the endless belt and the bed rub against each other when the sliding portion is inserted and withdrawn between the cared person and the bed, wherefore the bed is not rumpled as the sliding portion is moved, and the sliding portion can be smoothly inserted and withdrawn.

A pair of placing surfaces may be provided to be located at the opposite sides of at least one arm of a carer, and a carer's arm may be able to touch the cared person from above the placing surface. In this mode, an area for supporting the cared person can be increased since the cared person is supported by the placing surfaces at the opposite sides of the arm. Thus, the cared person can be stably held. Further, since the carer's arm can touch the cared person from above the placing surface, the cared person can be directly held by the arm in the case of an emergency such as a fall of the cared person and safety can be improved. Further, a sense of security can be given to the cared person.

The supporting apparatus may further comprise a lifting portion main body integral to the placing surface, and an input-portion supporting portion supporting the input portion, and the input-portion supporting portion may be displaceably supported in the lifting portion main body to be located at the first and second positions. In this mode, the input portion can be displaced between the first and second positions by moving the input-portion supporting portion itself forward or backward. Further, the input portion can be displaced between the first and second positions by moving the lifting portion itself forward or backward.

The supporting apparatus may further comprise a sensor capable of detecting a bed, and the input portion may be relatively moved forward when a distance between the sensor and the bed is in a specified value. In this mode, the input portion is automatically moved forward before the placing surface is inserted underneath the cared person. Thus, operation burdens can be reduced in the operation of setting the leading end of the supporting apparatus on the bed.

The supporting apparatus may further comprise a sensor disposed at the leading end of the placing surface, and the input portion may be relatively moved backward with respect to the placing surface when the contact of the sensor with the cared person is detected. In this mode, the input portion is automatically moved backward if the sensor comes into contact with the cared person at the time of inserting the placing surface underneath the cared person. Thus, the carer needs not bend over forward even when the placing surface is inserted underneath the cared person. As a result, operation burdens can be reduced.

The supporting apparatus may further comprise an input-portion supporting portion supporting the input portion, a sensor capable of detecting the presence or absence of a bed below the input-portion supporting portion, and the input portion may be kept at the second position while the presence of the bed below the input-portion supporting portion is detected by the sensor and may be moved downward from the second position when the bed is no longer detected. In this mode, a downward movement of the input portion can be prevented despite the presence of the bed. On the other hand, the input portion is automatically moved downward (retracted) if the bed is absent below the input-portion supporting portion, whereby the contact of the input portion with the cared person can be reliably prevented even if the carer cannot afford to operate the input portion.

A movement of the input portion relative to the placing surface may be stopped when the contact of the cared person and the input portion is judged upon moving the input portion from the second position to the first position with the cared person placed on the placing surface. In this state, the contact of the input portion with the cared person can be reliably prevented even if the carer cannot afford to operate the input portion.

The supporting apparatus may further comprise an input-portion supporting portion supporting the input portion, and a sensor capable of detecting the presence or absence of a bed below the input-portion supporting portion; a movement of the input portion relative to the placing surface may be stopped when the contact of the cared person and the input portion is judged upon moving the input portion from the second position to the first position with the cared person placed on the placing surface; the placing surface may be moved with this relative positional relationship kept while the presence of the bed below the input-portion supporting portion is detected by the sensor; and the input portion may be moved downward when the bed is no longer detected. In this mode, a downward movement of the input portion despite the presence of the bed can be prevented. The input portion is automatically moved downward (retracted) after the placing surface is moved backward if the bed is present below the input-portion supporting portion, whereby the contact of the input portion with the cared person can be reliably prevented even if the carer cannot afford to operate the input portion.

The present invention is also directed to a nursing robot system, comprising the supporting apparatus; a joint portion for changing the position and posture of a lifting portion including the placing surface; a joint driving device for changing the joint portion; and a controller for controlling the supporting apparatus and the joint driving device in accordance with the operation instruction inputted to the input portion.

In the present invention, there can be provided a nursing robot system using a supporting apparatus enabling a carer to hold up a cared person without taking such a posture imposing physical burdens such as low back pain on him and enabling a sense of security to be given to the cared person.

As described above, according to the present invention, there can be provided a-supporting apparatus enabling a carer to safely lift up a cared person without taking a posture imposing physical burdens such as low back pain on him when the carer supports and lifts up the cared person and without giving a sense of insecurity to the cared person, and a nursing robot system using such a supporting system.

### INDUSTRIAL APPLICABILITY

The present invention is applicable to a supporting apparatus for moving a cared person lying on a bed or the like to another location while supporting the cared person in a lying state at a hospital, at home or on the like site of nursing and particularly to a supporting apparatus capable of lifting up the cared person by inserting lifting portions for lifting up the cared person between the cared person and a bed and a nursing robot system using such a supporting apparatus.

This application is based on Japanese patent application No. 2006-254316 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A supporting apparatus for assisting an operation of holding up a cared person, comprising:
a placing surface on which the cared person can be placed, and
an input portion for inputting an operation input, the input portion being capable of being located at a first position and a second position located more backward relative to the placing surface than the first position in a direction away from the cared person.

2. A supporting apparatus according to claim 1, wherein the first position is located within a range where the fingers of a carer's hand gripping the input portion reach the cared person.

3. A supporting apparatus according to claim 1, wherein the input portion is vertically displaceable relative to the placing surface.

4. A supporting apparatus according to claim 3, further comprising an input-portion supporting portion rotatably supporting the input portion.

5. A supporting apparatus according to claim 4, the input-portion supporting portion is a U-shaped lever and the input portion is disposed at an end portion of the lever.

6. A supporting apparatus according to claim 1, further comprising:
a fixing portion including the input-portion supporting portion supporting the input portion, and
a sliding portion having the placing surface and slidable relative to the fixing portion.

7. A supporting apparatus according to claim 6, wherein:
a plurality of fixing portions are provided,
the sliding portion is slidably provided for each of the fixing portions, and
the respective sliding portions are independently slidable.

8. A supporting apparatus according to claim 6, further comprising:
a slide driving device for sliding the sliding portion,
a moving position detector for detecting position information of the sliding portion, and
a controller for controlling the slide driving device, the controller executing such a control based on the position information of the sliding portion that the sliding portion is movable within a specified range.

9. A supporting apparatus according to claim 8, further comprising an input position detector for detecting operating position information of the input portion, the controller executing such a control as to stop or move the sliding portion based on the position information of the sliding portion and the operating position information of the input portion.

10. A supporting apparatus according to claim 6, wherein the sliding portion includes an endless belt, and the placing surface is formed by the upper surface of the endless belt.

11. A supporting apparatus according to claim 10, wherein the upper surface of the endless belt is moved in a direction opposite to a moving direction of the sliding portion and substantially at the same speed as a sliding speed of the sliding portion.

12. A supporting apparatus according to claim 6, further comprising a rotatable roller array at the bottom side of the sliding portion.

13. A supporting apparatus according to claim 6, further comprising a lower conveyor portion including a rotatable endless belt at the bottom side of the sliding portion.

14. A supporting apparatus according to claim 13, wherein the lower conveyor portion drives the endless belt such that the lower surface of the endless belt moves in a direction opposite to a moving direction of the sliding portion and substantially at the same speed as a sliding speed of the sliding portion.

15. A supporting apparatus according to claim 1, wherein a pair of placing surfaces are provided to be located at the opposite sides of at least one arm of a carer, and the arm can be brought into contact with the cared person from above the placing surfaces.

16. A supporting apparatus according to claim 1, further comprising:
a lifting portion main body integral to the placing surface, and
an input-portion supporting portion supporting the input portion,
wherein the input-portion supporting portion is displaceably supported in the lifting portion main body so as the input portion to be located at the first and second positions.

17. A supporting apparatus according to claim 1, further comprising a sensor capable of detecting a bed, wherein the input portion is relatively moved forward when a distance between the sensor and the bed is in a specified value.

18. A supporting apparatus according to claim 1, further comprising a sensor disposed at the leading end of the placing surface, wherein the input portion is relatively moved backward with respect to the placing surface when the contact of the sensor with the cared person is detected.

19. A supporting apparatus according to claim 3, further comprising:
an input-portion supporting portion supporting the input portion,
a sensor capable of detecting a presence or absence of a bed below the input-portion supporting portion,
wherein the input portion is kept at the second position while the presence of the bed below the input-portion supporting portion is detected by the sensor and is moved downward from the second position when the bed is no longer detected.

20. A supporting apparatus according to claim 1, wherein a movement of the input portion relative to the placing surface is stopped when the contact of the cared person and the input portion is judged upon moving the input portion from the second position to the first position with the cared person placed on the placing surface.

21. A supporting apparatus according to claim 3, further comprising:
an input-portion supporting portion supporting the input portion,
a sensor capable of detecting a presence or absence of a bed below the input-portion supporting portion,
wherein a movement of the input portion relative to the placing surface is stopped when a contact of the cared person and the input portion is judged upon moving the input portion from the second position to the first position with the cared person placed on the placing surface, the placing surface is moved with this relative positional relationship kept while the presence of the bed below the input-portion supporting portion is detected by the sensor, and the input portion is moved downward when the bed is no longer detected.

22. A nursing robot system, comprising:
a supporting apparatus according to claim 1,
a joint portion for changing a position and posture of a lifting portion including the placing surface,
a joint driving device for changing the joint portion, and
a controller for controlling the supporting apparatus and the joint driving device in accordance with an operation instruction inputted to the input portion.
